(19) United States
(12) Patent Application Publication
(10) Pub. No.: US 2026/0211489 A1
(43) Pub. Date: Jul. 23, 2026

(54) INFORMATION PROCESSING APPARATUS

(71) Applicant: Lenovo Japan LLC, Tokyo (JP)

(72) Inventors: Liheng Mo, Kanagawa (JP); Masashi Nishio, Kanagawa (JP)

(73) Assignee: Lenovo Japan LLC, Tokyo (JP)

(21) Appl. No.: 19/421,110

(22) Filed: Dec. 16, 2025

(30) Foreign Application Priority Data
Jan. 17, 2025 (JP) 2025-006899

(51) Int. Cl. G06F 3/01

(52) U.S. Cl. CPC G06F 3/012

(57) ABSTRACT

An information processing apparatus includes: a first sensor which divides a predetermined detection range into a plurality of measurement units to measure a distance to an object in each of the measurement units; a second sensor which detects an angle of the first sensor with respect to a preset reference direction; a memory which temporarily stores distance information indicative of a distance in each of the measurement units measured by the first sensor; and a processor which executes processing based on the distance information in each of the measurement units. The processor performs: person detection processing to detect a range of a person present within the detection range based on the distance information in each of the measurement units; face direction determination processing to determine orientation of a face of the person based on the distance information in each of the measurement units in the range of the person.

### CROSS-REFERENCE TO RELATED APPLICATIONS

This application claims priority to Japanese Patent Application No. 2025-006899 filed on Jan. 17, 2025, the contents of which are hereby incorporated herein by reference in their entirety.

### TECHNICAL FIELD

The present invention relates to an information processing apparatus and a control method.

### BACKGROUND

In recent years, with the development of computer vision and the like, detection accuracy when detecting a face from a captured image captured by a camera has been getting higher, and person detection by face detection has also been performed. In the person detection by face detection, since the orientation of a face can also be detected in addition to simply detecting a person, control according to the orientation of the face (facing forward, facing sideways, or the like) can also be performed. For example, when the face is turned to the side, the screen brightness is reduced in order to prevent power from being wastefully consumed during a period when a user is not using the device.

However, for the detection of a face and the detection of the orientation of the face using the camera described above, the load of development related to image recognition and the like is high, and power consumption is also high because it is necessary to capture images using the camera. Therefore, a method of detecting the orientation of a face of a person while reducing power consumption in a simple way using a ToF (Time of Flight) method is also disclosed (for example, see Japanese Unexamined Patent Application Publication No. 2020-102151).

However, in the ToF method, since ranging is performed by dividing a detection range into 8×8 squares using, for example, a ranging sensor, the detection resolution and the FoV (Field of View: Detection Field of View) are limited compared with the face detection using the camera. Therefore, there is a case where only part of the body of a user falls within the range depending on the usage status, and there is a possibility that the screen brightness will be reduced unexpectedly. For example, there is a concern that the screen brightness may be reduced accidentally even though the user is using a clamshell (laptop) personal computer, such as a case where the user is using the clamshell (laptop) personal computer by opening it wide (by increasing the hinge angle) or a case where the user has poor posture.

### SUMMARY

One or more embodiments of the present invention provide an information processing apparatus and a control method for performing screen brightness control using the ToF method more properly.

An information processing apparatus according to one or more embodiments of the present invention includes: a first sensor for dividing a predetermined detection range into multiple measurement units to measure the distance to an object in each of the measurement units; a second sensor for detecting the angle of the first sensor with respect to a preset reference direction; a memory which temporarily stores distance information indicative of a distance in each of the measurement units measured by the first sensor; and a processor which executes processing based on the distance information in each of the measurement units, wherein the processor is configured to perform person detection processing to detect the range of a person present within the detection range based on the distance information in each of the measurement units, face direction determination processing to determine the orientation of a face of the person based on the distance information in each of the measurement units in the range of the person detected within the detection range, and screen brightness reduction processing to reduce the screen brightness of a display unit based on the detection result by the person detection processing and the determination result by the face direction determination processing, and when the angle detected using the second sensor is a predetermined threshold or more, the processor changes control content of the face direction determination processing based on the size of the range of the person detected within the detection range by the person detection processing.

The above information processing apparatus may be such that, in a case where the angle detected using the second sensor is less than the predetermined threshold, the processor enables the screen brightness reduction processing, and in a case where the angle detected using the second sensor is the predetermined threshold or more, when the range of a person is not detected within the detection range by the person detection processing, the processor disables the screen brightness reduction processing, when the range of a person is detected within the detection range by the person detection processing, the processor enables the screen brightness reduction processing to reduce the screen brightness of the display unit based on the determination result by the face direction determination processing.

The above information processing apparatus may also be such that, in the case where the angle detected using the second sensor is the predetermined threshold or more, and the range of a person is detected within the detection range by the person detection processing, when the size of the detected range of the person is within a predetermined first range, the processor determines whether or not the orientation of a face is a first direction facing forward toward the information processing apparatus by the face direction determination processing, when the determination result of the orientation of the face by the face direction determination processing is not the first direction, the processor reduces the screen brightness of the display unit by the screen brightness reduction processing, when the size of the detected range of the person is out of the first range, the processor fixes, to the first direction, the determination result of the orientation of the face by the face direction determination processing.

The above information processing apparatus may further be such that, in a case where the distance to the person is less than a predetermined distance based on the distance information in each of the measurement units in the range of the person detected by the person detection processing, when the orientation of the face is detected within a first direction range including the first direction by the face direction determination processing, the processor determines that the orientation of the face is the first direction, in a case where the distance to the person is the predetermined distance or more based on the distance information, when the orientation of the face is detected within a second direction range wider than the first direction range by the face direction determination processing, the processor determines that the orientation of the face is the first direction, and in the case where the angle detected using the second sensor is the predetermined threshold or more, and the size of the range of the person detected by the person detection processing is within the first range, when the size of the range of the person is smaller than the predetermined threshold within the first range, the processor determines that the orientation of the face is the first direction by the fact that the orientation of the face is detected within the second direction range by the face direction determination processing even though the distance to the person detected by the person detection processing is less than the predetermined distance.

The above information processing apparatus may further include: a first chassis including the first sensor; a second chassis; and a rotating mechanism which joins the first chassis and the second chassis in a manner to be rotatable from a closed first state where a first surface of the first chassis and a second surface of the second chassis face and overlap each other to a second state where the first surface and the second surface are open without overlapping each other, wherein the second sensor is a sensor for detecting an open angle between the first chassis and the second chassis according to the rotation as the angle of the first sensor with respect to the reference direction.

Further, the above information processing apparatus may be such that the second sensor is a sensor for detecting the angle of the first sensor with respect to a vertical direction as the angle of the first sensor with respect to the reference direction.

An information processing apparatus according to one or more embodiments of the present invention includes: a first sensor for dividing a predetermined detection range into multiple measurement units to measure the distance to an object in each of the measurement units; a second sensor for detecting the angle of the first sensor with respect to a preset reference direction; a memory which temporarily stores distance information indicative of a distance in each of the measurement units measured by the first sensor; and a processor which executes processing based on the distance information in each of the measurement units, wherein the processor is configured to perform person detection processing to detect the range of a person present within the detection range based on the distance information in each of the measurement units, face direction determination processing to determine the orientation of a face of the person based on the distance information in each of the measurement units in the range of the person detected within the detection range, and screen brightness reduction processing to reduce the screen brightness of a display unit, and in a case where the angle detected using the second sensor is less than a predetermined threshold, the processor performs the screen brightness reduction processing based on the detection result by the person detection processing and the determination result by the face direction determination processing, and in a case where the angle detected using the second sensor is the predetermined threshold or more, when the range of a person is not detected within the detection range by the person detection processing, the processor disables the screen brightness reduction processing, when the range of a person is detected within the detection range by the person detection processing, the processor performs the screen brightness reduction processing to reduce the screen brightness of the display unit based on the determination result by the face direction determination processing.

An information processing apparatus according to one or more embodiments of the present invention includes: a first sensor for dividing a predetermined detection range into multiple measurement units to measure the distance to an object in each of the measurement units; a memory which temporarily stores distance information indicative of a distance in each of the measurement units measured by the first sensor; and a processor which executes processing based on the distance information in each of the measurement units, wherein the processor is configured to perform person detection processing to detect the range of a person present within the detection range based on the distance information in each of the measurement units, face direction determination processing to determine the orientation of a face of the person based on the distance information in each of the measurement units in the range of the person detected within the detection range, and screen brightness reduction processing to reduce the screen brightness of a display unit based on the detection result by the person detection processing and the determination result by the face direction determination processing, and when the size of the range of the person detected by the person detection processing is within a predetermined first range, the processor determines whether or not the orientation of the face is a first direction facing forward toward the information processing apparatus by the face direction determination processing, when the determination result of the orientation of the face by the face direction determination processing is not the first direction, the processor reduces the screen brightness of the display unit by the screen brightness reduction processing, when the detected size of the range of the person is out of the first range, the processor fixes, to the first direction, the determination result of the orientation of the face by the face direction determination processing.

An information processing apparatus according to one or more embodiments of the present invention includes: a first sensor for dividing a predetermined detection range into multiple measurement units to measure the distance to an object in each of the measurement units; a memory which temporarily stores distance information indicative of a distance in each of the measurement units measured by the first sensor; and a processor which executes processing based on the distance information in each of the measurement units, wherein the processor is configured to perform person detection processing to detect the range of a person present within the detection range based on the distance information in each of the measurement units, face direction determination processing to determine the orientation of a face of the person based on the distance information in each of the measurement units in the range of the person detected within the detection range, and screen brightness reduction processing to reduce the screen brightness of a display unit based on the detection result by the person detection processing and the determination result by the face direction determination processing, and in a case where the distance to the person is less than a predetermined distance based on the distance information in each of the measurement units in the range of the person detected by the person detection processing, when the orientation of the face is detected within a first direction range including a first direction facing forward toward the information processing apparatus by the face direction determination processing, the processor determines that the orientation of the face is the first direction, in a case where the distance to the person is the predetermined distance or more based on the distance information, when the orientation of the face is detected within a second direction range wider than the first direction range by the face direction determination processing, the processor determines that the orientation of the face is the first direction, and when the size of the range of the person detected by the person detection processing is smaller than a predetermined threshold, the processor determines that the orientation of the face is the first direction by the fact that the orientation of the face is detected within the second direction range by the face direction determination processing even though the distance to the person detected by the person detection processing is less than the predetermined distance.

One or more embodiments of the present invention can perform screen brightness control using a ToF method more properly.

### BRIEF DESCRIPTION OF THE DRAWINGS

FIG. 1 is a perspective view illustrating a configuration example of the appearance of an information processing apparatus according to one or more embodiments.

FIG. 2 is a diagram illustrating an example of a person detection range of the information processing apparatus according to one or more embodiments.

FIG. 3 is an explanatory diagram of a determination method of a face orientation according to one or more embodiments.

FIG. 4 is a diagram illustrating an example of screen brightness reduction processing according to one or more embodiments.

FIG. 5 is an explanatory diagram of the screen brightness reduction processing in a state where an open angle θ is large according to one or more embodiments.

FIG. 6 is a schematic block diagram illustrating an example of the hardware configuration of the information processing apparatus according to one or more embodiments.

FIG. 7 is a schematic block diagram illustrating an example of the functional configuration of the information processing apparatus according to one or more embodiments.

FIG. 8 is a flowchart illustrating an example of the screen brightness reduction processing according to one or more embodiments.

FIG. 9 is a flowchart illustrating an example of the screen brightness reduction processing depending on the open angle θ according to one or more embodiments.

FIG. 10 is an explanatory diagram of screen brightness reduction processing according to one or more embodiments.

FIG. 11 is a flowchart illustrating an example of the face direction determination processing according to one or more embodiments.

FIG. 12 is an explanatory diagram of FoAs depending on the distances to a person according to one or more embodiments.

FIG. 13 is a diagram illustrating FoA switching at a short distance according to one or more embodiments.

FIG. 14 is a flowchart illustrating an example of face direction determination processing according to one or more embodiments.

FIG. 15 is a flowchart illustrating an example of face direction determination processing according to one or more embodiments.

### DETAILED DESCRIPTION

Embodiments of the present invention will be described below with reference to the accompanying drawings.

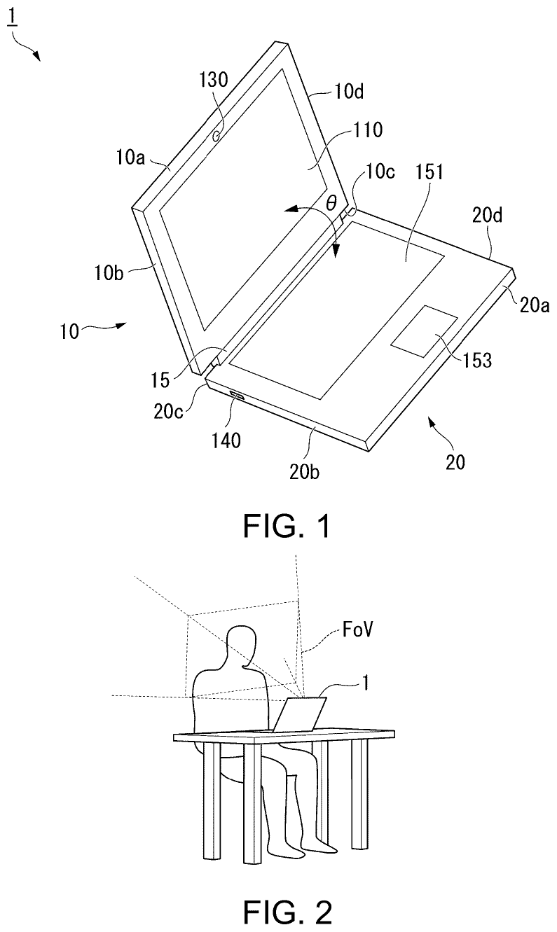

FIG. 1 is a perspective view illustrating a configuration example of the appearance of an information processing apparatus 1 according to one or more embodiments. The information processing apparatus 1 is, for example, a laptop (clamshell) PC (Personal Computer). The information processing apparatus 1 includes a first chassis 10, a second chassis 20, and a hinge mechanism 15. The first chassis 10 and the second chassis 20 are joined by using the hinge mechanism 15. The first chassis 10 is rotatable around an axis of rotation formed by the hinge mechanism 15 relative to the second chassis 20. An open angle (hinge angle) by the rotation between the first chassis 10 and the second chassis 20 is denoted by “θ” in FIG. 1.

The first chassis 10 is also called A cover or a display chassis. The second chassis 20 is also called C cover or a system chassis. In the following description, faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c toward the side face 20a is referred to as “front.” Further, a direction to the right when looking forward from the information processing apparatus 1 is referred to as “right side,” and a direction to the left is referred to as “left side.” Side faces on the right side of the first chassis 10 and the second chassis 20 are referred to as side faces 10b and 20b, respectively, and side faces on the left side are referred to as side faces 10d and 20d, respectively. Further, a state where the first chassis 10 and the second chassis 20 overlap each other and are completely closed (a state of open angle θ=0°) is referred to as a “closed state.” Surfaces of the first chassis 10 and the second chassis 20 on the face-to-face sides in the closed state are referred to as respective “inner surfaces,” and surfaces opposite to the inner surfaces are referred to as “outer surfaces.” Further, a state opposite to the closed state, where the first chassis 10 and the second chassis 20 are open, is referred to as an “open state.”

The appearance of the information processing apparatus 1 in FIG. 1 illustrates an example of the open state. The open state is a state where the side face 10a of the first chassis 10 and the side face 20a of the second chassis 20 are separated. In the open state, the respective inner surfaces of the first chassis 10 and the second chassis 20 appear. The open state is one of states where a user uses the information processing apparatus 1, and the information processing apparatus 1 is often used in a state where the open angle is typically about θ=100° to 140°. Note that the range of open angles θ to be the open state can be set arbitrarily according to the range of angles rotatable by the hinge mechanism 15, or the like.

A display unit 110 is provided on the inner surface of the first chassis 10. The display unit 110 is configured to include a liquid crystal display (LCD) or an organic EL (Electro Luminescence) display, and the like. Further, a ToF sensor 130 is provided in a peripheral area of the display unit 110 on the inner surface of the first chassis 10. For example, the ToF sensor 130 is arranged on the side of the side face 10a in the peripheral area of the display unit 110. Note that the position at which the ToF sensor 130 is arranged is just an example, and it may be elsewhere as long as the ToF sensor 130 can range a direction facing a display screen of the display unit 110.

The ToF sensor 130 is a ranging sensor for measuring the distance to an object (for example, a person) present in the direction facing the display screen of the display unit 110. For example, the ToF sensor 130 is configured to include a light-emitting part for emitting infrared light and a light-receiving part for receiving reflected light which is the infrared light returned after being emitted and reflected on the surface of the object. The ToF sensor 130 emits infrared light forward in a predetermined sampling cycle (for example, 1 Hz) and receives the reflected light of the emitted infrared light to output a ranging signal according to the distance to the object (for example, the person) using a ToF (Time-of-Flight) method for converting, into a distance, a time difference from light emission to light reception.

Further, a power button 140 is provided on the side face 20b of the second chassis 20. The power button 140 is an operating element used by the user to give an instruction to power on or power off, make a transition from a standby state to a normal operating state, make a transition from the normal operating state to the standby state, or the like. The normal operating state is an operating state of a system capable of executing processing without being particularly limited, which corresponds, for example, to so state defined in the ACPI (Advanced Configuration and Power Interface) specification.

The standby state is a state in which at least part of system processing is limited and power consumption is lower than that in the normal operating state. For example, the standby state may be the standby state or a sleep state, Modern Standby in Windows (registered trademark), or a state corresponding to S3 state (sleep state) defined in the ACPI specification. Further, a state in which at least the display of the display unit appears to be OFF (screen OFF), or a screen lock state may also be included as the standby state. The screen lock is a state in which an image preset to make a content being processed invisible (for example, an image for the screen lock) is displayed on the display unit, that is, an unusable state until the lock is released (for example, until the user is authenticated).

Further, a keyboard 151 and a touch pad 153 are provided on the inner surface of the second chassis 20 as input devices to accept user operation input. Note that a touch sensor may also be provided as an input device instead of or in addition to the keyboard 151 and the touch pad 153, or a mouse and an external keyboard may be connected. When the touch sensor is provided, an area corresponding to the display screen of the display unit 110 may be constructed as a touch panel for accepting operations. Further, a microphone used to input voice may be included in the input devices.

Note that, in the closed state where the first chassis 10 and the second chassis 20 are closed, the display unit 110 provided on the inner surface of the first chassis 10, and the keyboard 151 and the touch pad 153 provided on the inner surface of the second chassis 20 are covered with each other's chassis surfaces, and put in a state of being disabled from fulfilling the functions.

The information processing apparatus 1 executes HPD (Human Presence Detection) processing to detect a person present in front of the information processing apparatus 1 based on the ranging signal output from the ToF sensor 130.

FIG. 2 is a diagram illustrating an example of a ranging range of the ToF sensor 130 according to one or more embodiments. In the open state, the ToF sensor 130 arranged on the inner surface of the first chassis 10 measures the distance to an object (for example, a person) in the direction (forward) facing the inner surface of the first chassis 10. This ToF sensor 130 is a ranging sensor for detecting a person (for example, the user) present in front, and a detection range to detect the person is called a detection range FoV (Field of View: Detection Field of View). The detection range FoV corresponds to a range of angles in which the ToF sensor 130 can perform ranging.

For example, the ToF sensor 130 divides the detection range FoV into measurement units of 8×8 squares to perform ranging in each square (each measurement unit). Note that, since the purpose is to detect a person (user) who uses the information processing apparatus 1, the distance to an object away by a certain distance (for example, 2 m) or more may be excluded from ranging targets. Note that it is impossible in the first place to measure the distance to an object away by a distance that the infrared light cannot reach.

The information processing apparatus 1 controls the operating state of the system of the information processing apparatus 1 depending on the presence or absence of a person by the HPD processing. For example, when the presence of a person is detected (Presence=True) from a state where no person is detected in front of the information processing apparatus 1 (Presence=False) in the standby state, the information processing apparatus 1 boots the system and controls the system to the normal operating state.

Further, when it is detected that a person is present in front of the information processing apparatus 1, the information processing apparatus 1 detects the orientation of a face of the person based on ranging signals output from the ToF sensor 130. For example, the information processing apparatus 1 determines whether or not the face of the person is facing the direction of the information processing apparatus 1 (the direction of the display unit 110). Here, the state where the face of the person is facing the direction of the information processing apparatus 1 (the direction of the display unit 110) (that is, a state where the face is facing forward toward the information processing apparatus 1) is considered to be a state where the person is paying attention to the information processing apparatus 1. On the other hand, a state where the face of the person is not facing the direction of the information processing apparatus 1 (the direction of the display unit 110) (a state where the orientation of the face toward the information processing apparatus 1 is leftward, rightward, upward, or downward, that is, a state where the face is not facing forward toward the information processing apparatus 1) is considered to be a state where the person is not paying attention to the information processing apparatus 1.

### Face Orientation Determination Method

Next, a determination method for determining the orientation of a face based on ranging signals output from the ToF sensor 130 will be described. In one or more embodiments, the information processing apparatus 1 determines the front, left, right, up, or down orientation as the orientation of a face. The left/right orientation is the orientation of the face in the horizontal direction corresponding to the rotational direction around the vertical axis passing through the center of the face. Further, the up/down orientation is the orientation of the face in the vertical direction corresponding to the rotational direction around the horizontal axis passing through the center of the face.

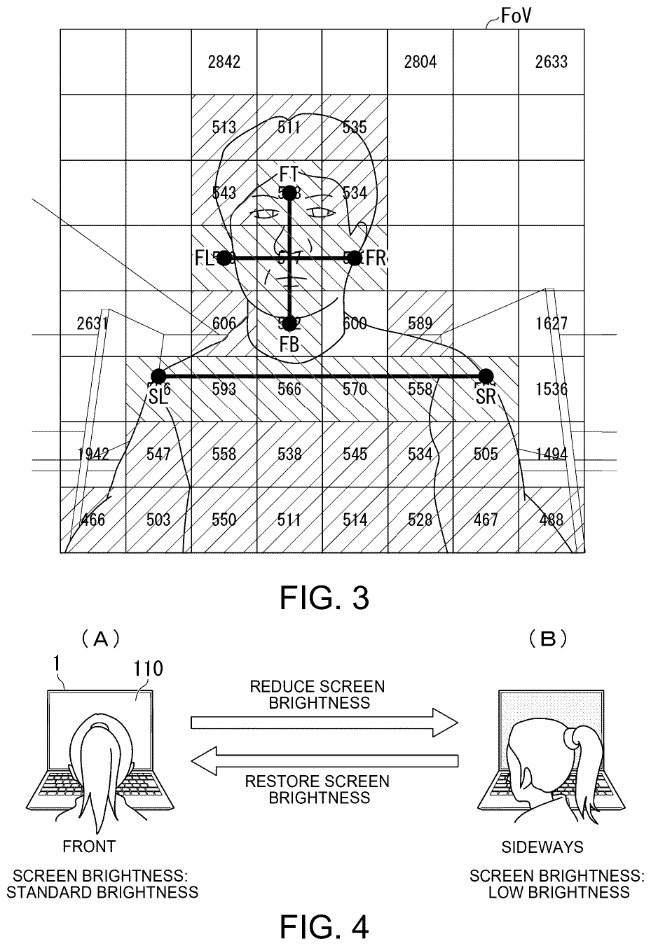

FIG. 3 is an explanatory diagram of the face orientation determination method according to one or more embodiments. In this figure, the detection range FoV is divided into 64-square measurement units of 8×8 squares, and an example of a ranging value in each square (each measurement unit) is numerically represented in each square. For example, the ranging value in each square is a distance value measured by the ToF sensor 130 in a predetermined cycle (for example, at one second interval). Since any person moves to some extent, the ranging value in each square is constantly changing. Therefore, the distance values measured in predetermined cycles (for example, at one second intervals) may be time-averaged to obtain a reliable ranging value.

In this figure, the unit of a ranging value numerically represented in each square is millimeters. In the illustrated example, a range of squares with ranging values of 450 to 610 is a range in which a person is present. Squares with ranging values of 1000 or more are ranging values of a ceiling and an object behind the person. Further, squares without any ranging value are squares that are impossible to measure distances because objects are too far away.

The range of a person is characterized in that the edge of the range generally has a mountain shape, and the width of a part above the shoulders of a body is shorter than the shoulder width. For example, when the edge of a range of squares, in which ranging values are obtained within 1 m (1000 mm) with small differences among them (here, about 450 to 610), is a mountain shape having the characteristics of a person, the information processing apparatus 1 detects the range as a range of the person (that is, detects that the person is present). In the illustrated example, six squares lined up from a square marked with SL (Shoulder Left) to a square marked with SR (Shoulder Right) in the horizontal direction (the left and right direction) correspond to a shoulder range (shoulder width), and the width of the part above the shoulder range is shorter than the shoulder width.

Further, the information processing apparatus 1 detects, as a face range, a range above the shoulder range and narrower in left and right width than the shoulder range. For example, the information processing apparatus 1 detects, as a face range, 3(horizontal)×4(vertical) squares above the shoulder range within the person range. The size of this face range corresponds to the range of a face of the person present at a distance where the person is using the information processing apparatus 1 (operating the keyboard) when ranging is performed by dividing the detection range FoV into 8×8 squares.

Note that the information processing apparatus 1 may also detect, as the face range, 3×3 squares above the shoulder range within the person range. Further, when ranging is performed in measurement units of the detection range FoV other than 8×8 squares, the face range is also set to a range according to the number of measurement units instead of 3×4 squares or 3×3 squares.

Further, as illustrated, it is assumed that the center square in the face range is the center of the face, and a ranging value in a square marked with FT (Face Top) above the center square is a ranging value of a top part (forehead position) of the face. It is also assumed that a ranging value in a square marked with FB (Face Bottom) below the center square is a ranging value of a bottom part (chin position) of the face. It is further assumed that a ranging value in a square marked with FL (Face Left) on the left side of the center square is a ranging value of a left part of the face. Further, it is assumed that a ranging value in a square marked with FR (Face Right) on the right side of the center square is a ranging value of a right part of the face.

Note that when the face range is composed of 3×3 squares, the center square in the face range is a center square of the 3×3 squares, while when the face range is composed of 3(horizontal)×4(vertical) squares, the center square is either a square in the second row and the center column or a square in the third row and the center column. Here, the lower square (the square in the third row) is prioritized as the center square.

Note that the upper square (the square in the second row) may also be prioritized as the center square. Further, the ranging values in both of the squares may be tracked to prioritize, as the center square, a square smaller in ranging value, or to prioritize, as the center square, a square larger in the amount of variation (amount of movement) of the ranging value.

The information processing apparatus 1 determines the orientation of the face based on the distance measurement values in the top part, bottom part, left part, and right part of the face. For example, the information processing apparatus 1 determines the orientation of the face in the vertical direction (up and down direction) based on a difference between the ranging value in the top part of the face and the ranging value in the bottom part of the face. Further, the information processing apparatus 1 determines the orientation of the face in the horizontal direction (left and right direction) based on a difference between the ranging value in the left part of the face and the ranging value in the right part of the face.

For example, when the difference between the ranging value in the top part of the face and the ranging value in the bottom part of the face is a predetermined threshold or more, and the ranging value in the top part of the face is smaller than the ranging value in the bottom part of the face, the information processing apparatus 1 determines that the orientation of the face is downward. On the other hand, when the difference between the ranging value in the top part of the face and the ranging value in the bottom part of the face is the predetermined threshold or more, and the ranging value in the bottom part of the face is smaller than the ranging value in the top part of the face, the information processing apparatus 1 determines that the orientation of the face is upward.

Further, when the difference between the ranging value in the left part of the face and the ranging value in the right part of the face is the predetermined threshold value or more, and the ranging value in the left part of the face is smaller than the ranging value in the right part of the face, the information processing apparatus 1 determines that the orientation of the face is rightward. On the other hand, when the difference between the ranging value in the left part of the face and the ranging value in the right part of the face is the predetermined threshold value or more, and the ranging value in the right part of the face is smaller than the ranging value in the left part of the face, the information processing apparatus 1 determines that the orientation of the face is leftward.

Further, when the difference between the ranging value in the top part of the face and the ranging value in the bottom part of the face is less than the predetermined threshold, and the difference between the ranging value in the left part of the face and the ranging value in the right part of the face is less than the predetermined threshold, the information processing apparatus 1 determines that the face is facing forward. Thus, the information processing apparatus 1 can determine the orientation of the face based on the ranging values in the top part, bottom part, left part, and right part of the face.

Note that the information processing apparatus 1 may also determine the orientation of the face in the vertical direction (up and down direction) and the horizontal direction (left and right direction) depending on in which part the ranging value is the smallest among the top part, bottom part, left part, and right part of the face. Further, when the differences among the ranging values in the top part, bottom part, left part, and right part of the face are less than the predetermined threshold, the information processing apparatus 1 may determine that the face is facing forward.

Further, the information processing apparatus 1 may detect a face angle in the up and down direction from the difference between the ranging value in the top part of the face and the ranging value in the bottom part of the face. Similarly, the information processing apparatus 1 may detect a face angle in the left and right direction from the difference between the ranging value in the left part of the face and the ranging value in the right part of the face. Then, the information processing apparatus 1 may determine the orientation of the face (for example, whether or not the orientation of the face is forward) based on the face angle in the up and down direction and the face angle in the left and right direction.

For example, the information processing apparatus 1 controls the screen brightness of the display unit 110 (dimming control) according to the determination result of the face orientation. Specifically, when the face orientation is turned to a state where the face is not facing forward (a state where the person is not paying attention to the information processing apparatus 1), the information processing apparatus 1 reduces the screen brightness of the display unit 110 to save power. Further, when the person present in front of the information processing apparatus 1 is no longer present, the information processing apparatus 1 may also reduce the screen brightness of the display unit 110. Thus, the information processing apparatus 1 can reduce the screen brightness of the display unit 110 to suppress wasteful power consumption in the state where the user is not present and when the user is not looking at the information processing apparatus 1 even though the user is present. This processing for reducing the screen brightness is called “screen brightness reduction processing” below.

Further, when the face orientation is turned to front facing again (when the person is paying attention to the information processing apparatus 1 again) in this screen brightness reduction processing, the information processing apparatus 1 restores the screen brightness to the screen brightness before being reduced.

In the following, the original screen brightness before being reduced is called “standard brightness,” and the screen brightness reduced from the standard brightness is called “low brightness.” The low brightness is a brightness at least lower than the standard brightness, but as the brightness becomes lower, the effect of power saving increases. For example, the low brightness may be set to a brightness of about 0 to 10% of the standard brightness.

FIG. 4 is a diagram illustrating an example of screen brightness reduction processing according to one or more embodiments. For example, the information processing apparatus 1 determines the orientation of a face of a person (user) present in front of the information processing apparatus 1 to determine whether or not the face is facing forward.

(A) in FIG. 4 illustrates a state where the face orientation toward the information processing apparatus 1 is forward, and it can be determined that the person is paying attention to the screen of the display unit 110. Therefore, the information processing apparatus 1 controls the screen brightness of the display unit 110 to the standard brightness. On the other hand, (B) in FIG. 4 illustrates a state where the face orientation toward the information processing apparatus 1 is not forward (for example, it is a sideways state), and it can be determined that the person is not paying attention to the screen of the display unit 110. Therefore, when the face orientation is changed from the front facing state illustrated at (A) of FIG. 4 to the sideways state illustrated at (B) of FIG. 4, the information processing apparatus 1 changes the screen brightness of the display unit 110 from the standard brightness to the low brightness. Further, when the face orientation is changed from the sideways state illustrated at (B) of FIG. 4 to the front facing state illustrated at (A) of FIG. 4, the information processing apparatus 1 restores the screen brightness of the display unit 110 from the low brightness to the standard brightness.

In the following, the detection result to indicate that a person (the range of a person) is detected in the person detection processing for detecting a person (the range of a person) present within the detection range FoV using the ToF sensor 130 is written as “Presence=True,” and the detection result to indicate that a person (the range of a person) is not detected is written as “Presence=False.” Further, in the face direction determination processing for determining the face orientation of a person present within the detection range FoV using the ToF sensor 130, the determination result to indicate that a person is facing forward (paying attention to the information processing apparatus 1) is written as “Attention=True,” and the determination result to indicate that the person is not facing forward (not paying attention to the information processing apparatus 1) is written as “Attention=False.”

Here, the person and face detection method based on distance information using the ToF sensor 130 is limited in terms of the detection resolution and the detection range FoV compared with the person and face detection using a camera. For example, since the detection range FoV is narrow, part of or the whole user's body may be out of the detection range FoV depending on the usage status. For example, when the user uses the information processing apparatus 1 in a state where the open angle θ is large, since the ranging direction of the ToF sensor 130 is facing upward, the detection range FoV is shifted upward to make the user's body difficult to fall within the detection range FoV. Therefore, conventionally, there have been cases where measures have been taken to disable the screen brightness reduction processing in the state where the open angle θ is large to prevent the screen brightness from being reduced because the user cannot be detected even though the user is present.

However, depending on the user's usage status (the user's posture, the positional relationship with the information processing apparatus 1, or the like), it may be possible to detect the user's body and face even in the state where the open angle θ is large. Therefore, the information processing apparatus 1 according to one or more embodiments enables the screen brightness reduction processing depending on the conditions even in the state where the open angle θ is large to achieve greater power saving.

The details will be described below. In a state where the open angle θ is not large (for example, 0 to 140°), the information processing apparatus 1 enables the screen brightness reduction processing. In other words, in the state where the open angle θ is not large (for example, 0 to 140°), the information processing apparatus 1 reduces the screen brightness both when a person (the range of a person) is not detected and when the person is not facing forward (Attention=False).

On the other hand, in a state where the open angle θ is large (for example, 140 to 180°), when a person (the range of a person) is not detected (Presence=False), the information processing apparatus 1 disables the screen brightness reduction processing, while when a person (the range of a person) is detected (Presence=True), the information processing apparatus 1 enables the screen brightness reduction processing. In other words, in the state where the open angle θ is large (for example, 140 to 180°), the information processing apparatus 1 reduces the screen brightness only when the person is not facing forward (Attention=False), and disables the screen brightness reduction processing (keeps the screen brightness at the standard brightness) when a person (the range of a person is not detected (Presence=False).

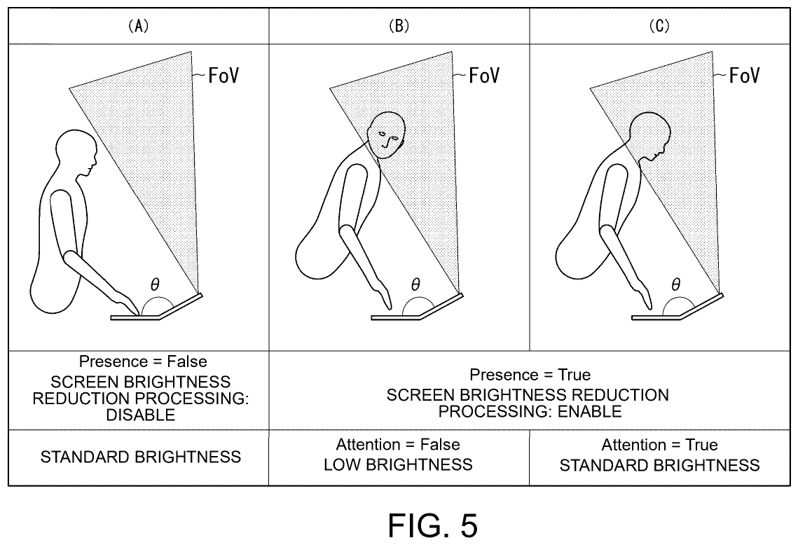

FIG. 5 is an explanatory diagram of the screen brightness reduction processing according to one or more embodiments in the case where the open angle θ is large. (A) in FIG. 5 illustrates a state where the user's body is not within the detection range FoV shifted upward because the open angle θ is large even though the user is present. The information processing apparatus 1 disables the screen brightness reduction processing because a person (the range of a person) is not detected (Presence=False), and controls the screen brightness to the standard brightness. Thus, the information processing apparatus 1 can prevent the screen brightness from being reduced accidentally even though the user is present in the state where the open angle θ is large.

(B) and (C) in FIG. 5 illustrate examples in which, although the detection range FoV is shifted upward because of the large open angle θ like at (A) of FIG. 5, the user falls within the detection range FoV due to the user's usage status (the user's posture, the positional relationship with the information processing apparatus 1, or the like). The information processing apparatus 1 enables the screen brightness reduction processing when a person (the range of a person) is detected (Presence=True).

In the example illustrated at (B) of FIG. 5, since the user is not facing forward (Attention=False), the screen brightness is changed to the low brightness. On the other hand, in the example illustrated at (C) of FIG. 5, since the user is facing forward (Attention=True), the screen brightness is kept at the standard brightness. Thus, even in the state where the open angle θ is large, when a person (the range of a person) is detected (Presence=True) due to the user's usage status (the user's posture, the positional relationship with the information processing apparatus 1, or the like), the information processing apparatus 1 can enable the screen brightness reduction processing to save power.

### Hardware Configuration of Information Processing Apparatus

Next, the configurations of the information processing apparatus 1 will be described in detail.

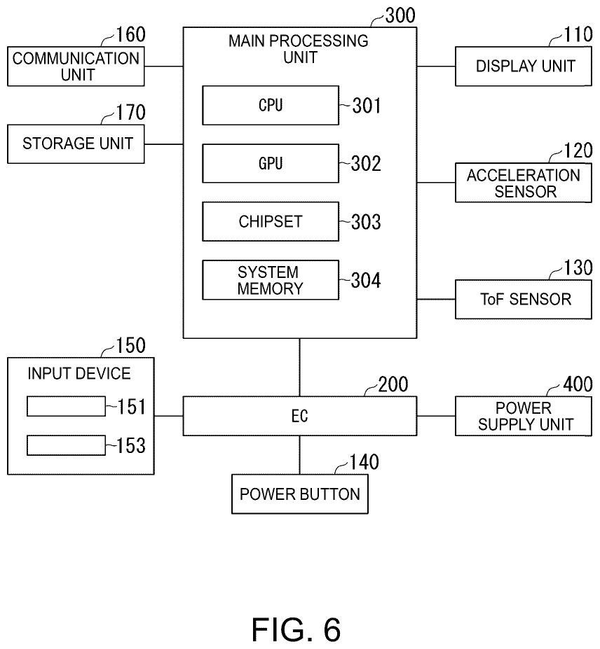

FIG. 6 is a schematic block diagram illustrating an example of the hardware configuration of the information processing apparatus 1 according to one or more embodiments. In FIG. 6, components corresponding to respective units in FIG. 1 are given the same reference numerals. The information processing apparatus 1 is configured to include the display unit 110, acceleration sensors 120, the TOF sensor 130, the power button 140, an input device 150, a communication unit 160, a storage unit 170, an EC (Embedded Controller) 200, a main processing unit 300, and a power supply unit 400.

The display unit 110 displays display data (images) generated based on system processing executed by the main processing unit 300, processing of application programs running on the system processing, and the like.

The acceleration sensors 120 are at least two acceleration sensors. The acceleration sensors 120 are provided inside the first chassis 10 and the second chassis 20, respectively. The acceleration sensors 120 detect the respective orientations of the first chassis 10 and the second chassis 20 and changes of the orientations. For example, the acceleration sensors 120 detect the three-axis acceleration of the first chassis 10 and the three-axis acceleration of the second chassis 20, and output detection signals indicative of the detection results.

As described above, the ToF sensor 130 is a ranging sensor using the ToF method to measure the distance to an object (for example, a person) present in front. For example, the ToF sensor 130 outputs ranging signals including ranging values as a result of measuring the distance to the object (for example, the person) present within the detection range FoV in the direction (forward) facing the inner surface of the first chassis 10.

The power button 140 outputs, to the EC 200, an operation signal according to a user operation. The input device 150 is an input unit, which is configured to include, for example, the keyboard 151 and the touch pad 153. In response to accepting operations on the keyboard 151 and the touch pad 153, the input device 150 outputs, to the EC 200, operation signals indicative of the operation details.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, a ROM, and the like. The storage unit 170 stores the OS, device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack), to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the functionality. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The main processing unit 300 is configured to include a CPU (Central Processing Unit) 301, a GPU (Graphic Processing Unit) 302, a chipset 303, and a system memory 304, where processing of various application programs is executable on the OS (Operating System) by system processing based on the OS.

The CPU 301 is a processor to execute processing based on a BIOS program, processing based on the OS program, processing based on application programs running on the OS, and the like. For example, the CPU 301 executes boot processing to boot the system from the standby state and make the transition to the normal operating state, sleep processing to make the transition from the normal operating state to the standby state, and the like. Further, the CPU 301 executes screen brightness reduction processing to reduce the screen brightness of the display unit 110 based on the determination result of the orientation of the face described above, and the like.

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires detection signals output from the acceleration sensors 120, ranging signals output from the ToF sensor 130, and the like.

The system memory 304 is used as a reading area of a program executed by the CPU 301 and a working area to write processed data.

Note that the CPU 301, the GPU 302, and the chipset 303 may also be integrated as one processor, or some or each of them may be configured as an individual processor, respectively. For example, in the normal operating state, the CPU 301, the GPU 302, and the chipset 303 are all operating, but in the standby state, only at least some of the functions of the chipset 303 are operating.

### Functional Configuration of Information Processing Apparatus

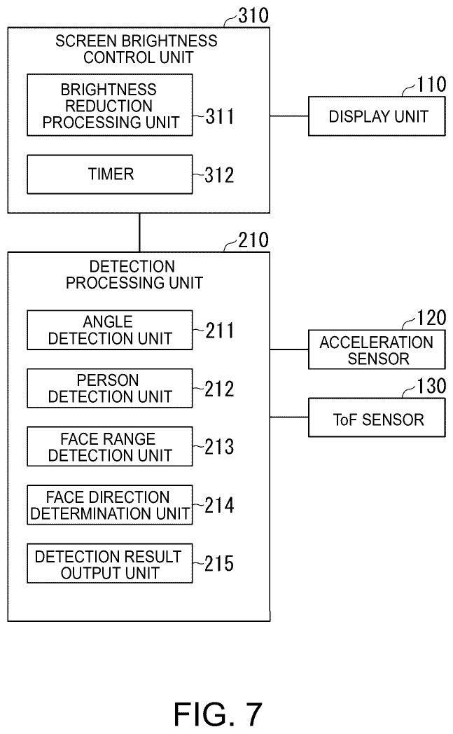

Next, the functional configuration of the information processing apparatus 1 to execute the screen brightness reduction processing described above will be described. FIG. 7 is a schematic block diagram illustrating an example of the functional configuration of the information processing apparatus 1 according to one or more embodiments. The information processing apparatus 1 includes a detection processing unit 210 that detects the open angle θ between the first chassis 10 and the second chassis, detects a person present in front of the information processing apparatus 1, and determines the orientation of a face, and a screen brightness control unit 310 that controls the screen brightness of the display unit 110 based on the detection results and the determination result by the detection processing unit 210.

The detection processing unit 210 includes an angle detection unit 211, a person detection unit 212, a face range detection unit 213, a face direction determination unit 214, and a detection result output unit 215 as functional components for the detection of the open angle θ, the detection of a person, the determination of the orientation of a face, and the like described above by the CPU 301 or the chipset 303 executing a specific program(s).

The angle detection unit 211 detects the open angle θ (relative angle) between the first chassis 10 and the second chassis 20 based on the detection signals output from the acceleration sensors 120. The angle detection unit 211 outputs the detection result of the open angle θ to the detection result output unit 215.

The person detection unit 212 performs person detection processing to detect a person (the range of a person) present within the detection range FoV based on the ranging values of the ToF sensor 130. For example, since any person moves to some extent unlike an object, the person detection unit 212 may exclude, from detection targets, an object that is completely stationary when detecting a person, and target only a moving (for example, slightly moving) object as a detection target.

Specifically, for example, as described with reference to FIG. 3, the person detection unit 212 acquires, from ranging signals output from the ToF sensor 130, a ranging value in each square (each measurement unit) obtained by dividing the detection range FoV into 64-square measurement units of 8×8 squares. Then, when the edge of a range of squares, in which ranging values are obtained within 1 m (1000 mm) with small differences among the ranging values (here, about 450 to 610), is a mountain shape having the characteristics of a person, the person detection unit 212 detects the range as the range of a person. The person detection unit 212 outputs the detection result by the person detection processing to the detection result output unit 215.

When the person (the range of the person) is detected by the person detection unit 212, the face range detection unit 213 performs face range detection processing to detect the range of a face of the person. For example, the face range detection unit 213 detects the range of a face of the person based on the edge shape of the detected range of the person. Specifically, the face range detection unit 213 detects the range of shoulders from the range of the person, and detects, as the range of a face, 3(horizontal)×4(vertical) squares or 3(horizontal)×3(vertical) squares above the shoulder range (see FIG. 3).

The face direction determination unit 214 performs face direction determination processing to determine the orientation of the face based on the ranging values within the range of the face detected by the face range detection unit 213. For example, the face direction determination unit 214 determines the orientation of the face based on differences among the ranging values in plural squares (measurement units) within the range of the face. For example, as described with reference to FIG. 3, the face direction determination unit 214 detects a face angle in the vertical direction (up and down direction) and a face angle in the horizontal direction (left and right direction based on differences among ranging values in the top, bottom, left, and right parts of the face, and determines the orientation of the face (for example, whether or not the orientation of the face is forward) based on the detected face angles. Note that the face direction determination unit 214 determines which part in the range of the face is close based on the ranging values in the plural squares (measurement units) within the range of the face.

Note that the face direction determination unit 214 may also determine whether or not at least the orientation of the face is forward. The face direction determination unit 214 outputs the determination result of the orientation of the face to the detection result output unit 215.

The detection result output unit 215 outputs, to the screen brightness control unit 310, information indicative of the detection result of the open angle θ by the angle detection unit 211. For example, the detection result output unit 215 outputs angle information indicative of the value of the open angle θ detected by the angle detection unit 211. Note that, based on the value of the open angle θ detected by the angle detection unit 211, the detection result output unit 215 may also output angle information indicating either the state where the open angle θ is not large (for example, 0 to 140°) or the state where the open angle θ is large (for example, 140 to 180°).

Further, the detection result output unit 215 outputs, to the screen brightness control unit 310, information indicative of the detection result by the person detection unit 212. For example, when a person (the range of a person) is detected based on the detection result by the person detection unit 212, the detection result output unit 215 outputs “Presence=True,” while when a person (the range of a person) is not detected, the detection result output unit 215 outputs “Presence=False.”

Further, the detection result output unit 215 outputs, to the screen brightness control unit 310, information indicative of the determination result by the face direction determination unit 214. For example, based on the determination result by the face direction determination unit 214, when the face is facing forward, the detection result output unit 215 outputs “Attention=True,” while when the face is not facing forward, the detection result output unit 215 outputs “Attention=False.”

The screen brightness control unit 310 is a functional component implemented by the CPU 11 executing the BIOS and OS programs. For example, the screen brightness control unit 310 includes a brightness reduction processing unit 311 and a timer 312 as functional components implemented by executing the OS program.

When the system is in the normal operating state, the brightness reduction processing unit 311 acquires the angle information on the open angle θ detected by the detection processing unit 210, the information indicative of the person detection result, and the information indicative of the determination result of the orientation of a face, and controls the screen brightness of the display unit 110 based on the acquired information.

In the state where the open angle θ is not large (for example, 0 to 140°), the brightness reduction processing unit 311 enables the screen brightness reduction processing. Specifically, when acquiring “Presence=False,” the brightness reduction processing unit 311 controls the screen brightness to the low brightness. On the other hand, in the case where “Presence=True” is acquired, when acquiring “Attention=True,” the brightness reduction processing unit 311 controls the screen brightness to the standard brightness, while when acquiring “Attention=False,” the brightness reduction processing unit 311 controls the screen brightness to the low brightness.

The timer 312 is a timer for measuring a waiting time after the acquisition of “Attention=False” from the detection processing unit 210 in the state where the brightness reduction processing unit 311 controls the screen brightness to the standard brightness until the control of the screen brightness to the low brightness. When acquiring “Attention=True” before a predetermined waiting time elapses even after acquiring “Attention=False,” the brightness reduction processing unit 311 maintains the standard brightness without controlling the screen brightness to the low brightness. After “Attention=False” is acquired, when “Attention=True” is not acquired during the predetermined waiting time, the brightness reduction processing unit 311 controls the screen brightness to the low brightness. Thus, the screen brightness can be prevented from being controlled to the low brightness when the user looks away for a moment while using the information processing apparatus 1. The predetermined waiting time is preset, for example, to ten seconds or the like. Note that this predetermined waiting time may also be settable by the user.

### Operation of Screen Brightness Reduction Processing

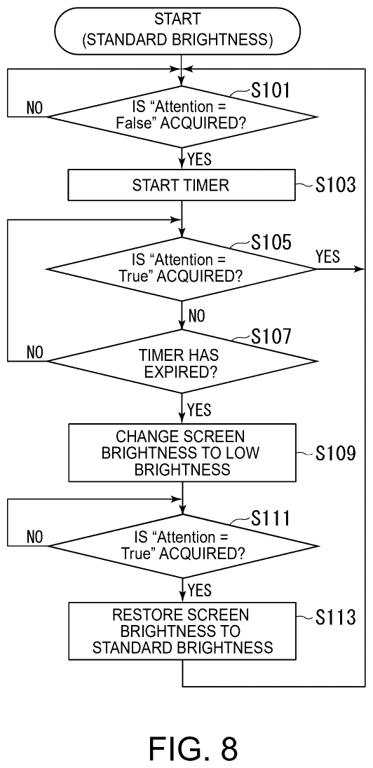

Referring next to FIG. 8, the operation of screen brightness reduction processing executed by the screen brightness control unit 310 will be described. FIG. 8 is a flowchart illustrating an example of the screen brightness reduction processing according to one or more embodiments. Here, it is assumed that the information processing apparatus 1 is in the normal operating state, the face of the person (user) is facing forward, and the screen brightness is set to the standard brightness.

(Step S101) The brightness reduction processing unit 311 determines whether or not to acquire “Attention=False” from the detection processing unit 210. When determining that “Attention=False” is not acquired (NO), the brightness reduction processing unit 311 performs the process in step S101 again. On the other hand, When determining that “Attention=False” is acquired (YES), the brightness reduction processing unit 311 starts measuring the waiting time using the timer 312 (step S103). Then, the brightness reduction processing unit 311 proceeds to a process in step S105.

(Step S105) The brightness reduction processing unit 311 determines whether or not to acquire “Attention=True” from the detection processing unit 210. When determining that “Attention=True” is not acquired (NO), the brightness reduction processing unit 311 proceeds to a process in step S107.

(Step S107) The brightness reduction processing unit 311 determines whether or not the predetermined waiting time (for example, ten seconds) has elapsed (that is, whether or not the timer has expired) based on the value of the timer 312. When determining that the predetermined waiting time (for example, ten seconds) has not elapsed yet (that is, that the timer has not expired (step S107: NO), the brightness reduction processing unit 311 returns to the process in step S105. When determining that “Attention=True” is acquired before the predetermined waiting time (for example, ten seconds) elapses (step S105: YES), the brightness reduction processing unit 311 returns to the process in step S101. At this time, the timer 312 is reset.

On the other hand, when determining in step S107 that the predetermined waiting time (for example, ten seconds) has elapsed (step S107: YES), the brightness reduction processing unit 311 changes the screen brightness to the low brightness (step S109). Then, the brightness reduction processing unit 311 proceeds to a process in step S111.

(Step S111) The brightness reduction processing unit 311 determines whether or not to acquire “Attention=True” from the detection processing unit 210. When determining that “Attention=True” is not acquired (NO), the brightness reduction processing unit 311 performs the process in step S111 again. On the other hand, when determining that “Attention=True” is acquired (YES), the brightness reduction processing unit 311 restores the screen brightness to the standard brightness (step S113).

Next, the screen brightness reduction processing in the state where the open angle θ is large (for example, 140 to 180°) will be described. When acquiring “Presence=False,” the brightness reduction processing unit 311 disables the screen brightness reduction processing, and fixes the screen brightness to the standard brightness (without reducing the screen brightness). On the other hand, when acquiring “Presence=True,” the brightness reduction processing unit 311 enables the screen brightness reduction processing. Then, when acquiring “Attention=True,” the brightness reduction processing unit 311 controls the screen brightness to the standard brightness, while when acquiring “Attention=False,” the brightness reduction processing unit 311 controls the screen brightness to the low brightness.

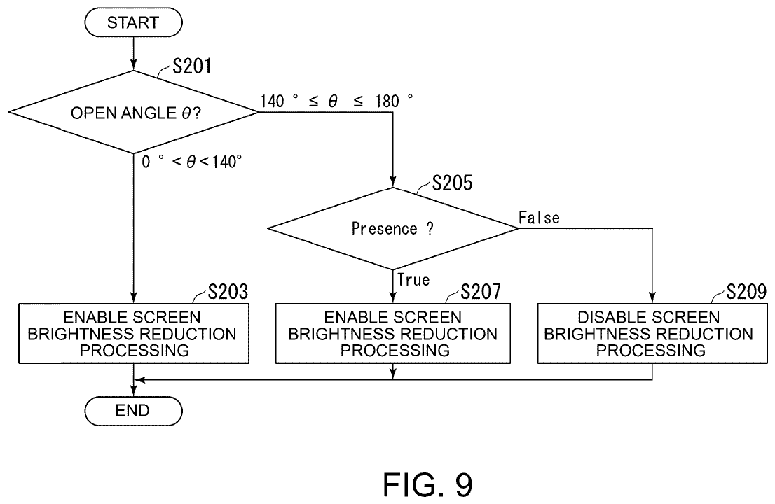

Referring here to FIG. 9, the operation of the screen brightness reduction processing in which the information processing apparatus 1 performs control to switch between enabling and disabling of the screen brightness reduction processing depending on the open angle e will be described.

FIG. 9 is a flowchart illustrating an example of the screen brightness reduction processing depending on the open angle θ according to one or more embodiments.

(Step S201) The brightness reduction processing unit 311 acquires the angle information indicative of the value of the open angle θ from the detection processing unit 210 to determine the open angle θ. When determining that the open angle θ is larger than 0° and smaller than 140° (0°<θ<140°), the brightness reduction processing unit 311 proceeds to a process in step S203. On the other hand, when determining that the open angle θ is not less than 140° and not more than 180° (140°≤θ≤180°), the brightness reduction processing unit 311 proceeds to a process in step S205.

(Step S203) The brightness reduction processing unit 311 enables the screen brightness reduction processing. In other words, in the state where the open angle θ is not large (for example, 0 to 140°), the brightness reduction processing unit 311 reduces the screen brightness from the standard brightness to the low brightness both when “Presence=False” is acquired and when “Attention=False” is acquired.

(Step S205) The brightness reduction processing unit 311 determines whether to acquire “Presence=True” or “Presence=False” as the detection result of a person (the range of a person) from the detection processing unit 210. When determining that “Presence=True” is acquired, the brightness reduction processing unit 311 proceeds to a process in step S207. On the other hand, when determining that “Presence=False” is acquired, the brightness reduction processing unit 311 proceeds to a process in step S209.

(Step S207) The brightness reduction processing unit 311 enables the screen brightness reduction processing.

(Step S209) The brightness reduction processing unit 311 disables the screen brightness reduction processing.

In other words, in the state where the open angle θ is large (for example, 140 to 180°), the brightness reduction processing unit 311 does not perform brightness reduction processing in the case of “Presence=False.” The brightness reduction processing unit 311 reduces the screen brightness from the standard brightness to the low brightness only when acquiring “Attention=False.”

As described above, the information processing apparatus 1 according to one or more embodiments includes: the ToF sensor 130 (an example of a first sensor) for dividing the detection range FoV (an example of a predetermined detection range) into multiple measurement units (for example, 8×8 squares) to measure the distance to an object in each of the measurement units; the acceleration sensors 120 (an example of a second sensor) for detecting the angle of the ToF sensor 130 with respect to a preset reference direction (for example, the open angle θ); the system memory 304 (an example of a memory) which temporarily stores a ranging value (an example of distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units. In the person detection processing, the information processing apparatus 1 detects the range of a person present within the detection range FoV based on the ranging value in each of the measurement units. Further, in the face direction determination processing, the information processing apparatus 1 determines the orientation of a face of the person based on the ranging value in each of the measurement units in the range of the person detected within the detection range FoV. Further, the information processing apparatus 1 performs the screen brightness reduction processing to reduce the screen brightness of the display unit 110.

For example, when the angle (for example, the open angle θ) detected using the acceleration sensors 120 is less than a predetermined threshold (for example, 0°<θ<140°), the information processing apparatus 1 enables the screen brightness reduction processing to reduce the screen brightness of the display unit 110 based on the detection result by the person detection processing and the determination result by the face direction determination processing. On the other hand, in the case where the angle (for example, the open angle θ) detected using the acceleration sensors 120 is the predetermined threshold or more (for example, 140°≤θ≤180°), when the range of a person is not detected within the detection range FoV by the person detection processing, the information processing apparatus 1 disables the screen brightness reduction processing, while when the range of a person is detected within the detection range FoV by the person detection processing, the information processing apparatus 1 enables the screen brightness reduction processing to reduce the screen brightness of the display unit 110 based on the determination result by the face direction determination processing.

Thus, the information processing apparatus 1 can reduce the screen brightness when the user is not facing forward to save power while suppressing the screen brightness from being reduced unintentionally due to user's usage status (the user's posture, the positional relationship with the information processing apparatus 1, or the like) even in the state where the angle of the ToF sensor 130 (for example, the open angle θ) is large. Therefore, the information processing apparatus 1 can perform screen brightness control using the ToF method more properly.

Further, the information processing apparatus 1 includes the first chassis 10 with the ToF sensor 130 provided therein, the second chassis 20, and the hinge mechanism 15 (an example of a rotating mechanism) that joins the first chassis 10 and the second chassis 20 in a manner to be rotatable from the closed state (first state) where the inner surface (an example of the a first surface) of the first chassis 10 and the inner surface (an example of a second surface) of the second chassis 20 face and overlap each other to the open state (second state) where the first chassis 10 and the second chassis 20 are open without overlapping each other. Then, the acceleration sensors 120 are sensors for detecting the open angle θ (opening degree) according to the rotation between the first chassis 10 and the second chassis 20 as the angle of the ToF sensor 130 with respect to the reference direction.

Thus, the information processing apparatus 1 can reduce the screen brightness when the user is not facing forward to save power while suppressing the screen brightness from being reduced unintentionally due to user's usage status (the user's posture, the positional relationship with the information processing apparatus 1, or the like) even in the state where the open angle θ between the first chassis 10 with the ToF sensor 130 provided therein and the second chassis 20 is large. Therefore, the information processing apparatus 1 can perform screen brightness control using the ToF method more properly.

Note that the acceleration sensors 120 may also be a sensor for detecting the angle of the ToF sensor 130 with respect to the vertical direction as the angle of the ToF sensor 130 with respect to the reference direction.

Thus, the information processing apparatus 1 can reduce the screen brightness when the user is not facing forward to save power while suppressing the screen brightness from being reduced unintentionally due to user's usage status (the user's posture, the positional relationship with the information processing apparatus 1, or the like) by detecting the angle of the ToF sensor 130 with respect to the vertical direction instead of the open angle θ between the first chassis 10 with the ToF sensor 130 provided therein and the second chassis 20. Therefore, the information processing apparatus 1 can perform screen brightness control using the ToF method more properly.

Further, a control method for the information processing apparatus 1 according to one or more embodiments is a control method for the information processing apparatus 1 including: the ToF sensor 130 (the example of the first sensor) for dividing the detection range FoV (the example of the predetermined detection range) into multiple measurement units to measure a distance in each of the measurement units; the acceleration sensors 120 (the example of the second sensor) for detecting the angle of the ToF sensor 130 with respect to a preset reference direction (for example, the open angle θ); the system memory 304 (the example of the memory) which temporarily stores a ranging value (the example of the distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units.

Then, the control method for the information processing apparatus 1 includes: a step of causing the processor to perform the person detection processing to detect the range of a person present within the detection range FoV based on the ranging value in each of the measurement units; a step of causing the processor to perform the face direction determination processing to determine the orientation of a face of the person based on the ranging value in each of the measurement units in the range of the person detected within the detection range FoV; and a step in which, when the angle (for example, the open angle θ) detected using the acceleration sensors 120 is less than a predetermined threshold (for example, 0°<θ<140°), the processor performs the screen brightness reduction processing to reduce the screen brightness of the display unit 110 based on the detection result by the person detection processing and the determination result by the face direction determination processing, wherein in the case where the angle (for example, the open angle θ) detected using the acceleration sensors 120 is the predetermined threshold or more (for example, 140°≤θ≤180°), when the range of a person is not detected within the detection range FoV by the person detection processing, the processor disables the screen brightness reduction processing, while when the range of a person is detected within the detection range FoV by the person detection processing, the processor enables the screen brightness reduction processing to reduce the screen brightness of the display unit 110 based on the determination result by the face direction determination processing.

Thus, the control method for the information processing apparatus 1 can reduce the screen brightness when the user is not facing forward to save power while suppressing the screen brightness from being reduced unintentionally due to user's usage status (the user's posture, the positional relationship with the information processing apparatus 1, or the like) even in the state where the angle of the ToF sensor 130 (for example, the open angle θ) is large. Therefore, the control method for the information processing apparatus 1 can perform screen brightness control using the ToF method more properly.

Note that the threshold used to determine the state where the open angle θ is large is not limited to 140°, which can be set arbitrarily as appropriate.

In the above embodiments, the process of enabling the screen brightness reduction processing (step S207 in FIG. 9) when a person (the range of a person) is detected (Presence=True) in the state where the open angle θ is large (for example, 140 to 180°) is described. However, in the state where the open angle θ is large, since the detection range FoV is shifted upward, there is a possibility that, even when a person (the range of a person) is detected, the position of a face may be out of the detection range FoV depending on the positional relationship between the person and the information processing apparatus 1 and hence the orientation of the face may not be able to be determined correctly.

In this case, since the person (the range of the person) is detected, it is considered that the user is using the information processing apparatus 1. However, since the orientation of the face cannot be determined correctly, there is a possibility that the screen brightness will be reduced as “Attention=False,” and this is undesirable. Therefore, in one or more embodiments, even in the case where a person (the range of a person) is detected (Presence=True) with a large open angle θ (for example, 140 to 180°), since there is a possibility that the orientation of a face may not be able to be determined correctly when the detected range of the person is narrow or wide, the person is excluded from the face direction determination processing and the determination result is fixed to “Attention=True.”

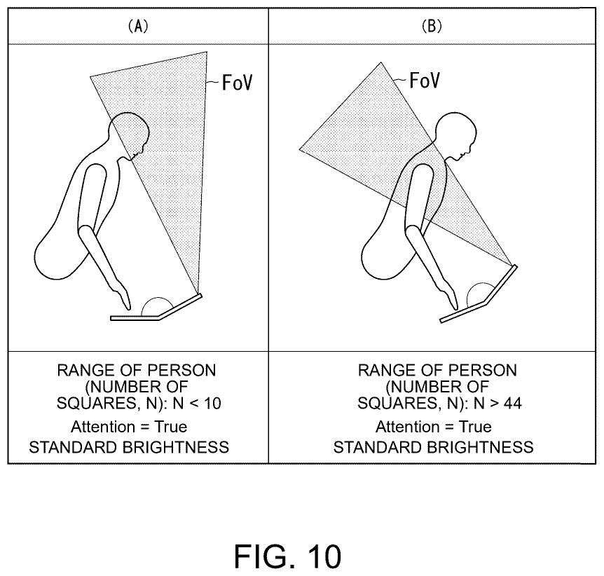

FIG. 10 is an explanatory diagram of the screen brightness reduction processing according to one or more embodiments. (A) in FIG. 10 illustrates an example when the detected range of a person is narrow. For example, when the number of squares, N, in the detected range of the person is less than 10 (N<10), since only a small part of the body of the person is within the detection range FoV, there is a possibility that the orientation of the face may not be able to be determined correctly. Therefore, when the number of squares, N, in the detected range of the person is less than 10 (N<10), the information processing apparatus 1 excludes the person from the face direction determination processing, and fixes the determination result to “Attention=True.” Thus, the information processing apparatus 1 can suppress the screen brightness from being reduced unintentionally even though the user is present.

(B) in FIG. 10 illustrates an example when the detected range of the person is wide. For example, when the number of squares, N, in the detected range of the person is more than 44 (N>44), most of the body of the person is within the detection range FoV, and there is a possibility that the orientation of the face may not be able to be determined correctly. Therefore, when the number of squares, N, in the detected range of the person is more than 44 (N>44), the information processing apparatus 1 excludes the person from the face direction determination processing, and fixes the determination result to “Attention=True.” Thus, the information processing apparatus 1 can suppress the screen brightness from being reduced unintentionally even though the user is present.

Note that when the number of squares, N, in the detected range of the person is not less than 10 and not more than 44 (10≤N≤44), the information processing apparatus 1 performs the face direction determination processing, and outputs “Attention=True” or “Attention=False” based on the determination result.

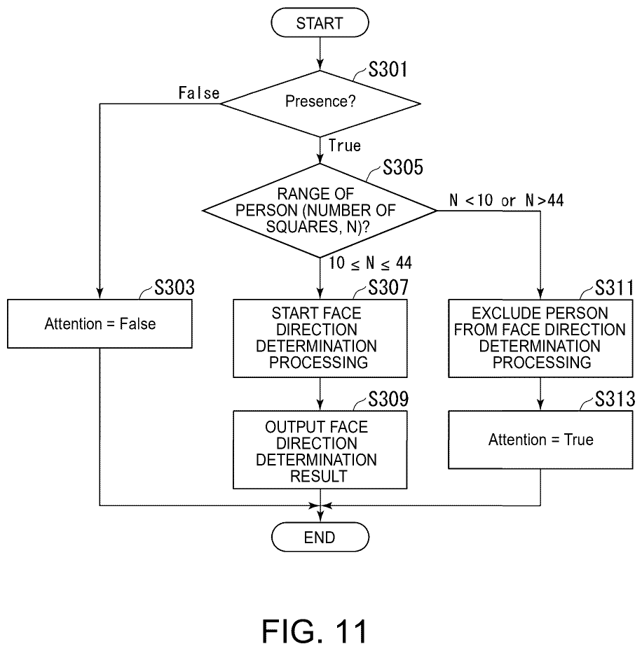

FIG. 11 is a flowchart illustrating an example of the face direction determination processing according to one or more embodiments. Referring to FIG. 11, the operation of the face direction determination processing according to one or more embodiments will be described.

(Step S301) The detection processing unit 210 detects a person (the range of a person) present within the detection range FoV based on the ranging values of the ToF sensor 130 to determine “Presence=True” or “Presence=False.” When determining “Presence=False,” the detection processing unit 210 proceeds to a process in step S303. On the other hand, when determining “Presence=True,” the detection processing unit 210 proceeds to a process in step S305.

(Step S303) Because of “Presence=False,” the detection processing unit 210 outputs “Attention=False.”

(Step S305) The detection processing unit 210 determines the detected range of the person (the number of squares, N). When determining that the detected range of the person (the number of squares, N) is not less than 10 and not more than 44 (10≤N≤44), the detection processing unit 210 proceeds to a process in step S307. On the other hand, when determining that the detected range of the person (the number of squares, N) is less than 10 (N<10) or more than 44 (N>44), the detection processing unit 210 proceeds to a process in step S311.

(Step S307) The detection processing unit 210 starts the face direction determination processing based on the ranging values of the ToF sensor 130. Then, the detection processing unit 210 proceeds to a process in step S309.

(Step S309) The detection processing unit 210 outputs “Attention=True” or “Attention=False” based on the determination result of the face direction determination processing.

(Step S311) The detection processing unit 210 excludes the person from the face direction determination processing. Then, the detection processing unit 210 proceeds to a process in step S313.

(Step S313) The detection processing unit 210 fixes the output of the determination result of the face direction determination processing to “Attention=True.”

As described above, the information processing apparatus 1 according to one or more embodiments includes: the TOF sensor 130 (the example of the first sensor) for dividing the detection range FoV (the example of the predetermined detection range) into multiple measurement units to measure the distance to an object in each of the measurement units; the acceleration sensors 120 (the example of the second sensor) for detecting the angle of the ToF sensor 130 with respect to a preset reference direction (for example, the open angle θ); the system memory 304 (the example of the memory) which temporarily stores a ranging value (the example of distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units.

In the person detection processing, the information processing apparatus 1 detects the range of a person present within the detection range FoV based on the ranging value in each of the measurement units. Further, in the face direction determination processing, the information processing apparatus 1 determines the orientation of a face of the person based on the ranging value in each of the measurement units in the range of the person detected within the detection range FoV. Then, the information processing apparatus 1 performs the screen brightness reduction processing to reduce the screen brightness of the display unit 110 based on the detection result by the person detection processing and the determination result by the face direction determination processing, and when the angle (for example, the open angle θ) detected using the acceleration sensors 120 is the predetermined threshold (for example, 140°) or more, the information processing apparatus 1 changes the control content of the face direction determination processing based on the size of the range of the person detected within the detection range FoV by the person detection processing.

Thus, the information processing apparatus 1 can perform screen brightness control using the ToF method more properly by changing the control content of the face direction determination processing depending on the positional relationship between the ranging direction of the ToF sensor 130 and the user.

For example, in the case where the angle (for example, the open angle θ) detected using the acceleration sensors 120 is the predetermined threshold (for example, 140°) or more, and the range of a person is detected within the detection range FoV by the person detection processing, when the size of the detected range of the person (the number of squares, N) is within a predetermined first range (for example, 10≤N≤44), the information processing apparatus 1 determines whether or not the orientation of a face is a first direction facing forward toward the processing apparatus 1 by the face direction determination processing, while when the size of the detected range of the person (the number of squares, N) is out of the first range (for example, N<10 or N>44), the information processing apparatus 1 fixes the determination result of the orientation of the face by the face direction determination processing to the first direction (forward) (Attention=True). Further, when the determination result of the orientation of the face by the face direction determination processing is not the first direction (forward), the information processing apparatus 1 reduces the screen brightness of the display unit 110 by the screen brightness reduction processing.

Thus, the information processing apparatus 1 can reduce the screen brightness when the face is not facing forward in the state where the face of the user is detected to save power while suppressing the screen brightness from being reduced unintentionally by the fact that the position of the face is out of the detection range FoV due to the positional relationship with the user. Therefore, the information processing apparatus 1 can perform screen brightness control using the ToF method more properly.

Further, a control method for the information processing apparatus 1 according to one or more embodiments is a control method for the information processing apparatus 1 including: the ToF sensor 130 (the example of the first sensor) for dividing the detection range FoV (the example of the predetermined detection range) into multiple measurement units to measure the distance to an object in each of the measurement units; the acceleration sensors 120 (the example of the second sensor) for detecting the angle of the ToF sensor 130 with respect to a preset reference direction (for example, the open angle θ); the system memory 304 (the example of the memory) which temporarily stores a ranging value (the example of distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units.

Then, the control method for the information processing apparatus 1 includes: a step of causing the processor to performs the person detection processing to detect the range of a person present within the detection range FoV based on the ranging value in each of the measurement units; a step of causing the processor to perform the face direction determination processing to determine the orientation of a face of the person based on the ranging value in each of the measurement units in the range of the person detected within the detection range FoV; a step of causing the processor to perform the screen brightness reduction processing to reduce the screen brightness of the display unit 110 based on the detection result by the person detection processing and the determination result by the face direction determination processing; and a step in which, when the angle (for example, the open angle θ) detected using the acceleration sensors 120 is a predetermined threshold (for example, 140°) or more, the processor changes the control content of the face direction determination processing based on the size of the range of the person detected within the detection range FoV by the person detection processing.

Thus, the control method for the information processing apparatus 1 can perform screen brightness control using the ToF method more properly by changing the control content of the face direction determination processing depending on the positional relationship between the ranging direction of the ToF sensor 130 and the user.

For example, when the size of the range of the person (the number of squares, N) detected by the person detection processing is within a predetermined first range (for example, 10≤N≤44), the control method for the information processing apparatus 1 determines whether or not the orientation of a face is a first direction by the face direction determination processing. Further, when the size of the detected range of the person (the number of squares, N) is out of the first range (for example, N<10 or N>44), the control method for the information processing apparatus 1 fixes the determination result of the orientation of the face by the face direction determination processing to the first direction (forward) (Attention=True). Then, when the determination result of the orientation of the face by the face direction determination processing is not the first direction (forward), the control method for the information processing apparatus 1 reduces the screen brightness of the display unit 110 by the screen brightness reduction processing.

Thus, in the state where the face of the user is detected, when the face is not facing forward, the control method for the information processing apparatus 1 can reduce the screen brightness to save power while suppressing the screen brightness from being reduced unintentionally by the fact that the position of the face is out of the detection range FoV due to the positional relationship with the user. Therefore, the control method for the information processing apparatus 1 can perform screen brightness control using the ToF method more properly.

Note that the information processing apparatus 1 may also perform the process of changing the control content of the face direction determination processing based on the size of the range of the person detected within the detection range FoV by the person detection processing regardless of whether or not the angle detected using the acceleration sensors 120 (for example, the open angle θ) is the predetermined threshold (for example, 140°) or more. For example, when the size of the range of the person (the number of squares, N) detected by the person detection processing is within the predetermined first range (for example, 10≤N≤44) without detecting the angle using the acceleration sensors 120 (for example, the open angle θ), the information processing apparatus 1 may determine whether or not the orientation of the face is the first direction facing forward toward the information processing apparatus 1 by the face direction determination processing, while when the size of the detected range of the person (the number of squares, N) is out of the first range (for example, N<10 or N>44), the information processing apparatus 1 may fix the determination result of the orientation of the face by the face direction determination processing to the first direction (forward) (Attention=True).

Note that the threshold (first range) for the detected range of the person (the number of squares, N) is not less than 10 and not more than 44 (10≤N≤44), but this threshold can be set arbitrarily.

In one or more embodiments, when determining whether or not the orientation of a face is forward based on the detected face angle, the face direction determination unit 214 changes, according to the distance to the person, the range of the face angle to determine that the orientation of the face is forward (FoA: Field of Attention).

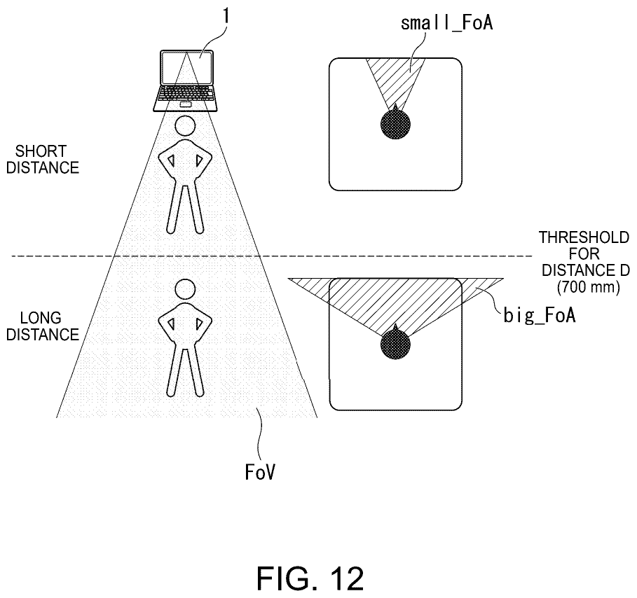

FIG. 12 is an explanatory diagram of FoAs depending on distances to a person according to one or more embodiments. When the distance to a person is far, the person may use the information processing apparatus 1 while looking at the information processing apparatus 1 from a position away from the center (for example, from a distant position in the left-right direction), compared with when the distance to a person is close. Therefore, when the distance to the person is far, the FoA to determine that the orientation of the face is forward is set bigger than that when the distance to the person is close. In other words, in the case of determining whether or not the orientation of the face is forward based on the detected face angle, when the distance to the person is close, the face direction determination unit 214 makes the determination using a small FoA, while when the distance to the person is far, the face direction determination unit 214 makes the determination using a bit FoA.

For example, when the distance to the person is less than a predetermined distance (for example, 700 mm), the face direction determination unit 214 determines whether or not the orientation of the face is forward using the small FoA.

On the other hand, when the distance to the person is the predetermined distance (for example, 700 mm) or more, the face direction determination unit 214 determines whether or not the orientation of the face is forward using the big FoA. Note that this predetermined distance is not limited to 700 mm, which can be set to any distance.

Further, the small FoA and the big FoA can be set to any angle ranges, respectively. As an example, when the forward direction is set to 0°, the small FoA is set to 0±30°, and the big FoA is set to 0±60°.

Here, in one or more embodiments, even when the face direction determination processing is performed in the state where the detected range of the person (the number of squares, N) is not less than 10 and not more than 44 (10≤N≤44), if the user takes an improper posture (for example, such a posture that the body is tilted at an angle) at a short distance, the face angle may be out of the range in the case of the small FoA and hence the screen brightness may be reduced unintentionally. Therefore, in one or more embodiments, the face direction determination unit 214 switches between the small FoA and the big FoA by taking into account not only the distance to the person but also the range of the person (the number of squares, N).

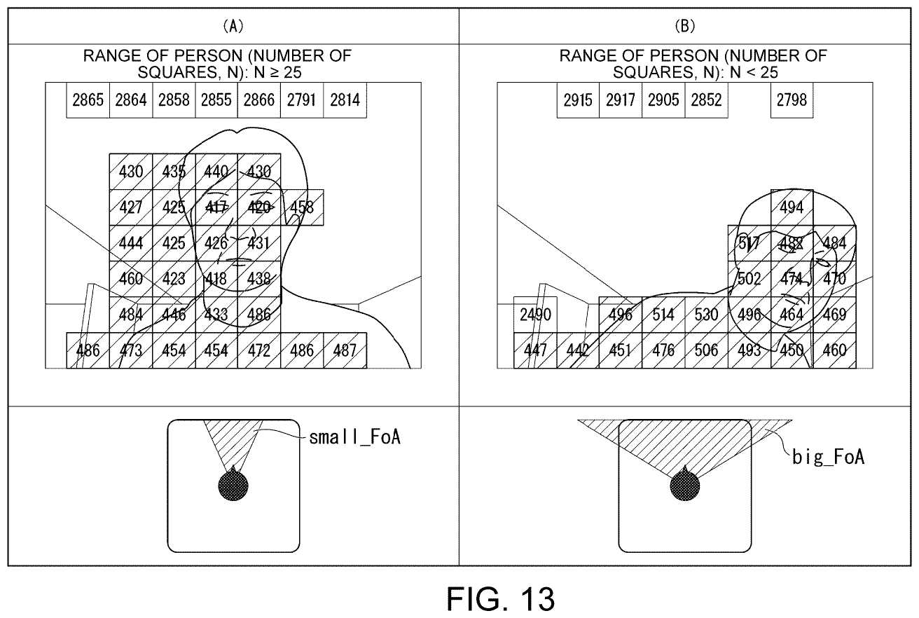

FIG. 13 is a diagram illustrating an example of FoA switching at a short distance according to one or more embodiments. When the user takes an improper posture as illustrated at (B) of FIG. 13, the detected range of the person (the number of squares, N) is reduced compared with when the user takes a proper posture as illustrated at (A) of FIG. 13. Therefore, when the range of the person (the number of squares, N) is less than 25 even in the state where the distance to the person is less than the predetermined distance (for example, 700 mm), the face direction determination unit 214 uses the big FoA to determine whether or not the orientation of the face is forward. Thus, the screen brightness can be suppressed from being reduced unintentionally by falsely detecting that the face is not facing forward when the user is using the information processing apparatus 1 while taking an improper posture.

Further, when the distance to the person is less than the predetermined distance (for example, 700 mm) and the range of the person (the number of squares, N) is 25 or more, the face direction determination unit 214 uses the small FoA to determine whether or not the orientation of the face is forward.

Note that the threshold for the range of the person (the number of squares, N) when determining whether or not the user is taking an improper posture is not limited to 25, which can be arbitrarily set to any threshold.

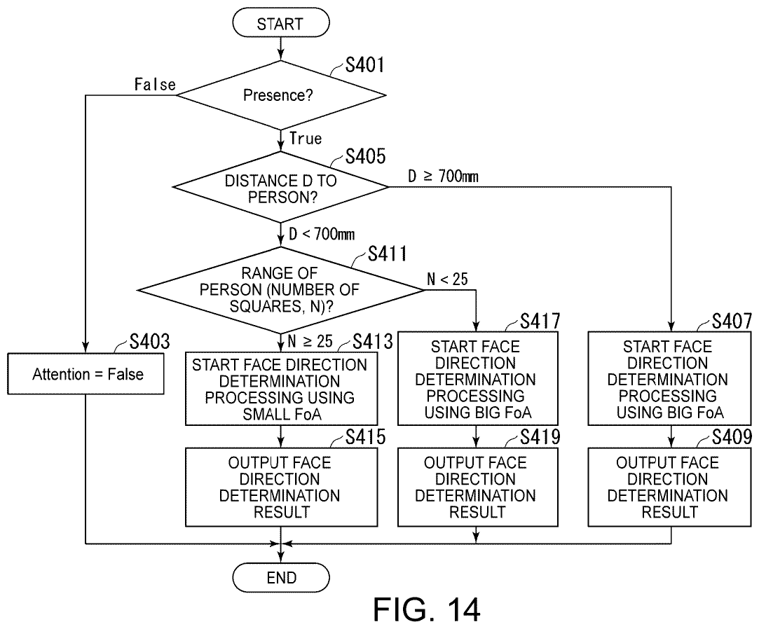

FIG. 14 is a flowchart illustrating an example of the face direction determination processing according to one or more embodiments. Referring to FIG. 14, the operation of the face direction determination processing according to one or more embodiments will be described.

(Step S401) The detection processing unit 210 detects a person (the range of a person) present within the detection range FoV based on ranging values of the ToF sensor 130, and determines “Presence=True” or “Presence=False.” When determining “Presence=False,” the detection processing unit 210 proceeds to a process in step S403. On the other hand, when determining “Presence=True,” the detection processing unit 210 proceeds to a process in step S405.

(Step S403) Since “Presence=False” is determined, the detection processing unit 210 outputs “Attention=False.”

(Step S405) The detection processing unit 210 determines the distance D to the person based on the ranging values of the ToF sensor 130. For example, the detection processing unit 210 makes the determination by comparing the average of the ranging values in the detected range of the person with the predetermined distance (for example, 700 mm). When determining that the distance D to the person is 700 mm or more (D≥700 mm), the detection processing unit 210 proceeds to a process in step S407. On the other hand, when determining that the distance D to the person is less than 700 mm (D<700), the detection processing unit 210 proceeds to a process in step S411.

(Step S407) When the distance to the person is far, the detection processing unit 210 starts the face direction determination processing using the big FoA. Then, the detection processing unit 210 proceeds to a process in step S409.

(Step S409) The detection processing unit 210 outputs “Attention=True” or (“Attention=False” based on the determination result of the face direction determination processing.

(Step S411) The detection processing unit 210 determines whether or not the detected range of the person (the number of squares, N) is 25 or more to determine whether the user's posture is proper or improper. When determining that the detected range of the person (the number of squares, N) is 25 or more, the detection processing unit 210 determines that the user's posture is proper, and proceeds to a process in step S413. On the other hand, when determining that the detected range of the person (the number of squares, N) is less than 25, the detection processing unit 210 determines that the user's posture is improper, and proceeds to a process in step S417.

(Step S413) Since the user's posture is proper at the short distance, the detection processing unit 210 starts the face direction determination processing using the small FoA. Then, the detection processing unit 210 proceeds to a process in step S415.

(Step S415) The detection processing unit 210 outputs “Attention=True” or “Attention=False” based on the determination result of the face direction determination processing.

(Step S417) When the user's posture is improper even at the short distance, the detection processing unit 210 starts the face direction determination processing using the big FoA. Then, the detection processing unit 210 proceeds to a process in step S419.

(Step S419) The detection processing unit 210 outputs “Attention=True” or “Attention=False” based on the determination result of the face direction determination processing.

As described above, the information processing apparatus 1 according to one or more embodiments includes: the ToF sensor 130 (the example of the first sensor) for dividing the detection range FoV (the example of the predetermined detection range) into multiple measurement units to measure the distance to an object in each of the measurement units; the acceleration sensors 120 (the example of the second sensor) for detecting the angle of the ToF sensor 130 with respect to a preset reference direction (for example, the open angle θ); the system memory 304 (the example of the memory) which temporarily stores a ranging value (the example of distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units. In the person detection processing, the information processing apparatus 1 detects the range of a person present within the detection range FoV based on the ranging value in each of the measurement units. Further, in the face direction determination processing, the information processing apparatus 1 determines the orientation of a face of the person based on the ranging value in each of the measurement units in the range of the person detected within the detection range FoV. Further, the information processing apparatus 1 performs the screen brightness reduction processing to reduce the screen brightness of the display unit 110 based on the detection result by the person detection processing and the determination result by the face direction determination processing.

Further, in the case where the distance to the person is less than the predetermined distance (for example, 700 mm) based on the distance information in each of the measurement units in the range of the person detected by the person detection processing, when the orientation of the face (the face angle) is detected within a first direction range (for example, the small FoA) including the first direction (forward) by the face direction determination processing, the information processing apparatus 1 determines that the orientation of the face is the first direction (forward) (Attention=True). On the other hand, in the case where the distance to the person is the predetermined distance (for example, 700 mm) or more based on the distance information in each of the measurement units in the range of the person detected by the person detection processing, when the orientation of the face (face angle) is detected within a second direction range (for example, the big FoA) wider than the first direction range by the face direction determination processing, the information processing apparatus 1 determines that the orientation of the face is the first direction (forward) (Attention=True). Then, in the case where the angle (for example, the open angle θ) detected using the acceleration sensors 120 is the predetermined threshold (for example, 140°) or more, and the size of the range of the person (the number of squares, N) detected by the person detection processing is within the first range (for example, 10≤N≤44), when the size of the range of the person is smaller than the predetermined threshold (for example, 25) within the first range, the information processing apparatus 1 determines that the orientation of the face is the first direction (forward) (Attention=True) by the fact that the orientation of the face is detected within the second direction range (for example, the big FoA) by the face direction determination processing even though the distance to the person detected by the person detection processing is less than predetermined distance.

Thus, the information processing apparatus 1 can suppress the screen brightness from being reduced unintentionally by the fact that the user takes an improper posture (for example, such a posture that the body is tilted at an angle) at a short distance. Therefore, the information processing apparatus 1 can perform screen brightness control using the ToF method more properly.

Further, a control method for the information processing apparatus 1 according to one or more embodiments is a control method for the information processing apparatus 1 including: the ToF sensor 130 (the example of the first sensor) for dividing the detection range FoV (the example of the predetermined detection range) into multiple measurement units to measure the distance to an object in each of the measurement units; the acceleration sensors 120 (the example of the second sensor) for detecting the angle of the ToF sensor 130 with respect to a preset reference direction (for example, the open angle θ); the system memory 304 (the example of the memory) which temporarily stores a ranging value (the example of distance information) indicative of a distance in each of the measurement units measured by the ToF sensor 130; and a processor (for example, the CPU 301, the chipset 303, or the like) which executes processing (for example, the person detection processing, the face direction determination processing, and the like) based on the ranging value in each of the measurement units.

Then, the control method for the information processing apparatus 1 includes: a step of causing the processor to perform the person detection processing to detect the range of a person present within the detection range FoV based on the ranging value in each of the measurement units; a step of causing the processor to perform the face direction determination processing to determine the orientation of a face of the person based on the ranging value in each of the measurement units in the range of the person detected within the detection range FoV; and a step of causing the processor to perform the screen brightness reduction processing to reduce the screen brightness of the display unit 110 based on the detection result by the person detection processing and the determination result by the face direction determination processing, wherein in the case where the distance to the person is less than the predetermined distance (for example, 700 mm) based on distance information in each of the measurement units in the range of the person detected by the person detection processing, when the orientation of the face (face angle) is detected within the first direction range (for example, the small FoA) including the first direction (forward) by the face direction determination processing, the processor determines that the orientation of the face is the first direction (forward) (Attention =True), while in the case where the distance to the person is the predetermined distance (for example, 700 mm) or more, when the orientation of the face (face angle) is detected within the second direction range (for example, the big FoA) wider than the first direction range by the face direction determination processing, the processor determines that the orientation of the face is the first direction (forward) (Attention=True). Further, in the case where the angle (for example, the open angle θ) detected using the acceleration sensors 120 is the predetermined threshold (for example, 140°) or more, and the size of the range of the person (the number of squares, N) detected by the person detection processing is within the first range (for example, 10≤N≤44), when the size of the range of the person is smaller than the predetermined threshold (for example, 25) within the first range, the processor determines that the orientation of the face is the first direction (forward) (Attention=True) by the fact that the orientation of the face is detected within the second direction range (for example, the big FoA) by the face direction determination processing even though the distance to the person detected by the person detection processing is less than the predetermined distance (for example, 700 mm).

Thus, the control method for the information processing apparatus 1 can suppress the screen brightness from being reduced unintentionally by the fact that the user takes an improper posture (for example, such a posture that the body is tilted at an angle) at a short distance. Therefore, the control method for the information processing apparatus 1 can perform screen brightness control using the ToF method more properly.

Note that the information processing apparatus 1 may also perform the process of changing the control content of the face direction determination processing based on the size of the range of the person detected within the detection range FoV by the person detection processing regardless of whether or not the angle detected using the acceleration sensors 120 (for example, the open angle θ) is the predetermined threshold (for example, 140°) or more. For example, in the case where the size of the range of the person (the number of squares, N) detected by the person detection processing is within the first range (for example, 10≤N≤44) without detecting the angle (for example, the open angle θ) using the acceleration sensors 120, when the size of the range of the person is smaller than the predetermined threshold (for example, 25) within the first range, the information processing apparatus 1 may determine that the orientation of the face is the first direction (forward) (Attention=True) by the fact that the orientation of the face is detected within the second direction range (for example, the big FoA) by the face direction determination processing even though the distance to the person detected by the person detection processing is less than the predetermined distance (for example, 700 mm).

In one or more embodiments, face direction determination processing in a combination of the face direction determination processing according to one or more embodiments (see FIG. 11) and the face direction determination processing according to one or more embodiments (see FIG. 14) will be described.

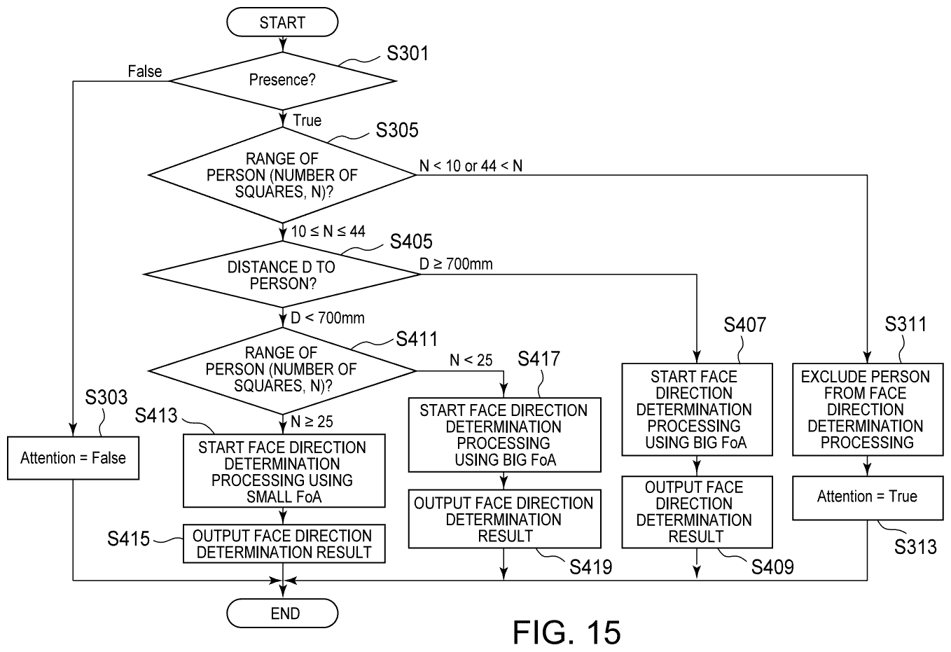

FIG. 15 is a flowchart illustrating an example of the face direction determination processing according to one or more embodiments. Referring to FIG. 15, the operation of the face direction determination processing according to one or more embodiments will be described. Note that processes corresponding to the respective processes illustrated in FIG. 11 or FIG. 14 are given the same reference numerals in FIG. 15.

(Step S301) The detection processing unit 210 detects a person (the range of a person) present within the detection range FoV based on the ranging values of the ToF sensor 130 to determine “Presence=True” or “Presence=False.” When determining “Presence=False,” the detection processing unit 210 proceeds to a process in step S303. On the other hand, when determining “Presence=True,” the detection processing unit 210 proceeds to a process in step S305.

(Step S303) Because of “Presence=False,” the detection processing unit 210 outputs “Attention=False.”

(Step S305) The detection processing unit 210 determines the detected range of the person (the number of squares, N). When determining that the detected range of the person (the number of squares, N) is less than 10 (N<10) or more than 44 (N>44), the detection processing unit 210 proceeds to a process in step S311. On the other hand, when determining that the detected range of the person (the number of squares, N) is not less than 10 and not more than 44 (10≤N≤44), the detection processing unit 210 proceeds to a process in step S405.

(Step S311) The detection processing unit 210 excludes the person from the face direction determination processing. Then, the detection processing unit 210 proceeds to a process in step S313.

(Step S313) The detection processing unit 210 fixes the output of the determination result of the face direction determination processing to “Attention=True.”

(Step S405) The detection processing unit 210 determines distance D to the person based on the ranging values of the ToF sensor 130. For example, the detection processing unit 210 makes the determination by comparing the average of the ranging values in the detected range of the person with the predetermined distance (for example, 700 mm). When determining that the distance D to the person is 700 mm or more (D≥700 mm), the detection processing unit 210 proceeds to a process in step S407. On the other hand, when determining that the distance D to the person is less than 700 mm (D<700), the detection processing unit 210 proceeds to a process in step S411.

(Step S407) When the distance to the person is far, the detection processing unit 210 starts the face direction determination processing using the big FoA. Then, the detection processing unit 210 proceeds to a process in step S409.

(Step S409) The detection processing unit 210 outputs “Attention=True” or “Attention=False” based on the determination result of the face direction determination processing.

(Step S411) The detection processing unit 210 determines whether or not the detected range of the person (the number of squares, N) is 25 or more to determine whether the user's posture is proper or improper. When determining that the detected range of the person (the number of squares, N) is 25 or more, the detection processing unit 210 determines that the user's posture is proper, and proceeds to a process in step S413. On the other hand, when determining that the detected range of the person (the number of squares, N) is less than 25, the detection processing unit 210 determines that the user's posture is improper, and proceeds to a process in step S417.

(Step S413) Since the user's posture is proper at the short distance, the detection processing unit 210 starts the face direction determination processing using the small FoA. Then, the detection processing unit 210 proceeds to a process in step S415.

(Step S415) The detection processing unit 210 outputs “Attention=True” or “Attention=False” based on the determination result of the face direction determination processing.

(Step S417) When the user's posture is improper even at the short distance, the detection processing unit 210 starts the face direction determination processing using the big FoA. Then, the detection processing unit 210 proceeds to a process in step S419.

(Step S419) The detection processing unit 210 outputs “Attention=True” or “Attention=False” based on the determination result of the face direction determination processing.

While the embodiments of this invention have been described in detail above with reference to the accompanying drawings, the specific configurations are not limited to those described above, and design changes and the like are included without departing from the scope of this invention. For example, the respective components described in the embodiments described above can be combined arbitrarily.

Further, in the aforementioned embodiments, the information processing apparatus 1 detects the orientation of a face using ranging values in four squares of the top part, bottom part, left part, and right part of the face within the detected range of the face, but the information processing apparatus 1 may detect the orientation of a face (upward, downward, or forward) using ranging values in two squares of the top part and bottom part of the face, or may detect the orientation of the face (leftward, rightward, or forward) using ranging values in two squares of the left part and right part of the face.

Further, the information processing apparatus 1 may detect the orientation of a face using ranging values in five or more squares within the detected range of the face (for example, 3×4 squares or 3×3 squares). For example, the information processing apparatus 1 may detect the orientation of a face using ranging values in five squares of the center, top part, bottom part, left part and right part of the face within the range of the detected face. Further, the information processing apparatus 1 may detect the orientation of a face using ranging values in eight squares around the center of the face within the range of the detected face, or may detect the orientation of a face using ranging values in nine squares with the ranging value for the center of the face further added.

Further, in the aforementioned embodiments, the example in which the detection range FoV is divided into 8×8-square measurement units to perform ranging in each square (each measurement unit) using the ToF sensor 130 is described, but the number of squares into which the detection range FoV is divided may be other than 8×8 squares.

Further, in the aforementioned embodiments, the configuration example in which the ToF sensor 130 is built in the information processing apparatus 1 is described, but the present invention is not limited to this example. For example, the ToF sensor 130 does not have to be built in the information processing apparatus 1, which may also be attachable to the information processing apparatus 1 (for example, onto any one of the side faces 10a, 10b, 10c, and the like) and communicably connected to the information processing apparatus 1 wirelessly or by wire as an external accessory of the information processing apparatus 1.

Further, in the aforementioned embodiments, the ToF sensor 130 using infrared light is described as an example of a ranging sensor, but the present invention is not limited to this example. For example, it may also be a ranging sensor using laser or ultrasonic waves.

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 1, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the information processing apparatus 1 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 of the aforementioned embodiments is not limited to the laptop PC, which may also be a desktop PC, a tablet terminal device, a smartphone, a gaming device, a multimedia terminal, or the like, for example.

### DESCRIPTION OF SYMBOLS

1 information processing apparatus
10 first chassis
20 second chassis
15 hinge mechanism
110 display unit
120 acceleration sensor
130 ToF sensor
140 power button
150 input device
151 keyboard
153 touch pad
160 communication unit
170 storage unit
200 EC
210 detection processing unit
211 angle detection unit
212 person detection unit
213 face range detection unit
214 face direction determination unit
215 detection result output unit
300 main processing unit
301 CPU
302 GPU
303 chipset
304 system memory
310 screen brightness control unit
311 brightness reduction processing unit
312 timer
400 power supply unit

What is claimed is:

1. An information processing apparatus comprising:
a first sensor which divides a predetermined detection range into a plurality of measurement units to measure a distance to an object in each of the measurement units;
a second sensor which detects an angle of the first sensor with respect to a preset reference direction;
a memory which temporarily stores distance information indicative of a distance in each of the measurement units measured by the first sensor; and
a processor which executes processing based on the distance information in each of the measurement units, wherein
the processor is configured to perform:
person detection processing to detect a range of a person present within the detection range based on the distance information in each of the measurement units;
face direction determination processing to determine orientation of a face of the person based on the distance information in each of the measurement units in the range of the person detected within the detection range; and
screen brightness reduction processing to reduce screen brightness of a display unit based on a detection result by the person detection processing and a determination result by the face direction determination processing, and
when the angle detected using the second sensor is a predetermined threshold or more, the processor changes control content of the face direction determination processing based on a size of the range of the person detected within the detection range by the person detection processing.

2. The information processing apparatus according to claim 1, wherein
in a case where the angle detected using the second sensor is less than the predetermined threshold, the processor enables the screen brightness reduction processing, and
in a case where the angle detected using the second sensor is the predetermined threshold or more,
when the range of a person is not detected within the detection range by the person detection processing, the processor disables the screen brightness reduction processing,
when the range of a person is detected within the detection range by the person detection processing, the processor enables the screen brightness reduction processing to reduce the screen brightness of the display unit based on the determination result by the face direction determination processing.

3. The information processing apparatus according to claim 2, wherein
in the case where the angle detected using the second sensor is the predetermined threshold or more and the range of a person is detected within the detection range by the person detection processing,
when a size of the detected range of the person is within a predetermined first range, the processor determines whether or not the orientation of a face is a first direction facing forward toward the information processing apparatus by the face direction determination processing,
when the determination result of the orientation of the face by the face direction determination processing is not the first direction, the processor reduces the screen brightness of the display unit by the screen brightness reduction processing,
when the size of the detected range of the person is out of the first range, the processor fixes, to the first direction, the determination result of the orientation of the face by the face direction determination processing

4. The information processing apparatus according to claim 3, wherein
in a case where the distance to the person is less than a predetermined distance based on the distance information in each of the measurement units in the range of the person detected by the person detection processing, when the orientation of the face is detected within a first direction range including the first direction by the face direction determination processing, the processor determines that the orientation of the face is the first direction,
in a case where the distance to the person is the predetermined distance or more based on the distance information, when the orientation of the face is detected within a second direction range wider than the first direction range by the face direction determination processing, the processor determines that the orientation of the face is the first direction, and
in the case where the angle detected using the second sensor is the predetermined threshold or more and the size of the range of the person detected by the person detection processing is within the first range, when the size of the range of the person is smaller than the predetermined threshold within the first range, the processor determines that the orientation of the face is the first direction when the orientation of the face is detected within the second direction range by the face direction determination processing, even though the distance to the person detected by the person detection processing is less than the predetermined distance.

5. The information processing apparatus according to claim 1, further comprising:
a first chassis including the first sensor;
a second chassis; and
a rotating mechanism which joins the first chassis and the second chassis in a manner to be rotatable from a closed first state where a first surface of the first chassis and a second surface of the second chassis face and overlap each other to a second state where the first surface and the second surface are open without overlapping each other,
wherein the second sensor is a sensor for detecting an open angle according to the rotation between the first chassis and the second chassis as the angle of the first sensor with respect to the reference direction.

6. The information processing apparatus according to claim 1, wherein the second sensor is a sensor for detecting the angle of the first sensor with respect to a vertical direction as the angle of the first sensor with respect to the reference direction.

7. An information processing apparatus comprising:
a first sensor which divides a predetermined detection range into a plurality of measurement units to measure a distance to an object in each of the measurement units;
a second sensor which detects an angle of the first sensor with respect to a preset reference direction;
a memory which temporarily stores distance information indicative of a distance in each of the measurement units measured by the first sensor; and
a processor which executes processing based on the distance information in each of the measurement units, wherein
the processor is configured to perform:
person detection processing to detect a range of a person present within the detection range based on the distance information in each of the measurement units;
face direction determination processing to determine orientation of a face of the person based on the distance information in each of the measurement units in the range of the person detected within the detection range; and
screen brightness reduction processing to reduce screen brightness of a display unit, and
in a case where the angle detected using the second sensor is less than a predetermined threshold, the processor performs the screen brightness reduction processing based on a detection result by the person detection processing and a determination result by the face direction determination processing, and
in a case where the angle detected using the second sensor is the predetermined threshold or more,
when the range of a person is not detected within the detection range by the person detection processing, the processor disables the screen brightness reduction processing,
when the range of a person is detected within the detection range by the person detection processing, the processor performs the screen brightness reduction processing to reduce the screen brightness of the display unit based on the determination result by the face direction determination processing.

8. An information processing apparatus comprising:
a first sensor which divides a predetermined detection range into a plurality of measurement units to measure a distance to an object in each of the measurement units;
a memory which temporarily stores distance information indicative of a distance in each of the measurement units measured by the first sensor; and
a processor which executes processing based on the distance information in each of the measurement units, wherein
the processor is configured to perform:
person detection processing to detect a range of a person present within the detection range based on the distance information in each of the measurement units;
face direction determination processing to determine orientation of a face of the person based on the distance information in each of the measurement units in the range of the person detected within the detection range; and
screen brightness reduction processing to reduce screen brightness of a display unit based on a detection result by the person detection processing and a determination result by the face direction determination processing, and
when a size of the range of the person detected by the person detection processing is within a predetermined first range, the processor determines whether or not the orientation of the face is a first direction facing forward toward the information processing apparatus by the face direction determination processing,
when the determination result of the orientation of the face by the face direction determination processing is not the first direction, the processor reduces the screen brightness of the display unit by the screen brightness reduction processing
when the detected size of the range of the person is out of the first range, the processor fixes, to the first direction, the determination result of the orientation of the face by the face direction determination processing.

9. An information processing apparatus comprising:
a first sensor which divides a predetermined detection range into a plurality of measurement units to measure a distance to an object in each of the measurement units;
a memory which temporarily stores distance information indicative of a distance in each of the measurement units measured by the first sensor; and
a processor which executes processing based on the distance information in each of the measurement units, wherein
the processor is configured to perform:
person detection processing to detect a range of a person present within the detection range based on the distance information in each of the measurement units;
face direction determination processing to determine orientation of a face of the person based on the distance information in each of the measurement units in the range of the person detected within the detection range; and
screen brightness reduction processing to reduce screen brightness of a display unit based on a detection result by the person detection processing and a determination result by the face direction determination processing, and
in a case where a distance to the person is less than a predetermined distance based on the distance information in each of the measurement units in the range of the person detected by the person detection processing, when the orientation of the face is detected within a first direction range including a first direction facing forward toward the information processing apparatus by the face direction determination processing, the processor determines that the orientation of the face is the first direction,
in a case where the distance to the person is the predetermined distance or more based on the distance information, when the orientation of the face is detected within a second direction range wider than the first direction range by the face direction determination processing, the processor determines that the orientation of the face is the first direction, and
when a size of the range of the person detected by the person detection processing is smaller than a predetermined threshold, the processor determines that the orientation of the face is the first direction when the orientation of the face is detected within the second direction range by the face direction determination processing, even though the distance to the person detected by the person detection processing is less than the predetermined distance.
